(19) United States
(12) Patent Application Publication
(10) Pub. No.: US 2008/0062429 A1
(43) Pub. Date: Mar. 13, 2008

(54) LOW COHERENCE DENTAL OCT IMAGING

(76) Inventors: Rongguang Liang, Penfield, NY (US); Michael A. Marcus, Honeoye Falls, NY (US); Peter D. Burns, Fairport, NY (US); Victor C. Wong, Rochester, NY (US); Paul O. McLaughlin, Rochester, NY (US); Mark E. Bridges, Spencerport, NY (US); David L. Patton, Webster, NY (US)

Correspondence Address: Carestream Health Inc,, 150 Verona Street, Rochester, NY, 14608, US

(21) Appl. No.: 11/530,913

(22) Filed: Sep. 12, 2006

(51) Int. Cl. G01B 11/02

(52) U.S. Cl. 356/497; 356/512

(57) ABSTRACT

A method for obtaining an image of a tooth obtains an area image of the tooth (20) surface and identifies a region of interest from the area image by positioning a marker (146) on the area image. The marker (146) corresponds to at least a portion of the region of interest and identifies a scanning area. An optical coherence tomography (OCT) image is then obtained over the scanning area.

### CROSS REFERENCE TO RELATED APPLICATIONS

Reference is made to commonly-assigned copending U.S. application Ser. No. 11/262,869, filed Oct. 31, 2005, entitled METHOD FOR DETECTION OF CARIES, by Wong et al.; U.S. application Ser. No. 11/408,360, filed Apr. 21, 2006, entitled OPTICAL DETECTION OF DENTAL CARIES by Wong et al.; and U.S. patent application Ser. No. ______, filed herewith, entitled APPARATUS FOR CARIES DETECTION, by Liang et al., the disclosures of which are incorporated herein.

### FIELD OF THE INVENTION

This invention generally relates to methods and apparatus for dental imaging and more particularly relates to an apparatus for caries detection using low coherence OCT imaging.

### BACKGROUND OF THE INVENTION

In spite of improvements in detection, treatment, and prevention techniques, dental caries remains a widely prevalent condition affecting people of all age groups. If not properly and promptly treated, caries can lead to permanent tooth damage and even to loss of teeth.

Traditional methods for caries detection include visual examination and tactile probing with a sharp dental explorer device, often assisted by radiographic (x-ray) imaging. Detection using these methods can be somewhat subjective, varying in accuracy due to many factors, including practitioner expertise, location of the infected site, extent of infection, viewing conditions, accuracy of x-ray equipment and processing, and other factors. There are also hazards associated with conventional detection techniques, including the risk of damaging weakened teeth and spreading infection with tactile methods as well as exposure to x-ray radiation. By the time caries is evident under visual and tactile examination, the disease is generally in an advanced stage, requiring a filling and, if not timely treated, possibly leading to tooth loss.

In response to the need for improved caries detection methods, there has been considerable interest in improved imaging techniques that do not employ x-rays. One method that has been commercialized employs fluorescence, caused when teeth are illuminated with high intensity blue light. This technique, termed quantitative light-induced fluorescence (QLF), operates on the principle that sound, healthy tooth enamel yields a higher intensity of fluorescence under excitation from some wavelengths than does de-mineralized enamel that has been damaged by caries infection. The strong correlation between mineral loss and loss of fluorescence for blue light excitation is then used to identify and assess carious areas of the tooth. A different relationship has been found for red light excitation, a region of the spectrum for which bacteria and bacterial by-products in carious regions absorb and fluoresce more pronouncedly than do healthy areas.

Among proposed solutions for optical detection of caries are the following:
U.S. Pat. No. 4,515,476 (Ingmar) discloses use of a laser for providing excitation energy that generates fluorescence at some other wavelength for locating carious areas.
U.S. Pat. No. 6,231,338 (de Josselin de Jong et al.) discloses an imaging apparatus for identifying dental caries using fluorescence detection.
U.S. Patent Application Publication No. 2004/0240716 (de Josselin de Jong et al.) discloses methods for improved image analysis for images obtained from fluorescing tissue.

Among commercialized products for dental imaging using fluorescence behavior is the QLF Clinical System from Inspektor Research Systems BV, Amsterdam, The Netherlands. Using a different approach, the Diagnodent Laser Caries Detection Aid from KaVo Dental Corporation, Lake Zurich, Ill., detects caries activity monitoring the intensity of fluorescence of bacterial by-products under illumination from red light.

U.S. Patent Application Publication No. 2004/0202356 (Stookey et al.) describes mathematical processing of spectral changes in fluorescence in order to detect caries in different stages with improved accuracy. Acknowledging the difficulty of early detection when using spectral fluorescence measurements, the '2356 Stookey et al. disclosure describes approaches for enhancing the spectral values obtained, effecting a transformation of the spectral data that is adapted to the spectral response of the camera that obtains the fluorescent image.

While the disclosed methods and apparatus show promise in providing non-invasive, non-ionizing imaging methods for caries detection, there is still room for improvement. One recognized drawback with existing techniques that employ fluorescence imaging relates to image contrast. The image provided by fluorescence generation techniques such as QLF can be difficult to assess due to relatively poor contrast between healthy and infected areas. As noted in the '2356 Stookey et al. disclosure, spectral and intensity changes for incipient caries can be very slight, making it difficult to differentiate non-diseased tooth surface irregularities from incipient caries.

Overall, it is well recognized that, with fluorescence techniques, the image contrast that is obtained corresponds to the severity of the condition. Accurate identification of caries using these techniques often requires that the condition be at a more advanced stage, beyond incipient or early caries, because the difference in fluorescence between carious and sound tooth structure is very small for caries at an early stage. In such cases, detection accuracy using fluorescence techniques may not show marked improvement over conventional methods. Because of this shortcoming, the use of fluorescence effects appears to have some practical limits that prevent accurate diagnosis of incipient caries. As a result, a caries condition may continue undetected until it is more serious, requiring a filling, for example.

Detection of caries at very early stages is of particular interest for preventive dentistry. As noted earlier, conventional techniques generally fail to detect caries at a stage at which the condition can be reversed. As a general rule of thumb, incipient caries is a lesion that has not penetrated substantially into the tooth enamel. Where such a caries lesion is identified before it threatens the dentin portion of the tooth, remineralization can often be accomplished, reversing the early damage and preventing the need for a filling. More advanced caries, however, grows increasingly more difficult to treat, most often requiring some type of filling or other type of intervention.

In order to take advantage of opportunities for non-invasive dental techniques to forestall caries, it is necessary that caries be detected at the onset. In many cases, as is acknowledged in the '2356 Stookey et al. disclosure, this level of detection has been found to be difficult to achieve using existing fluorescence imaging techniques, such as QLF. As a result, early caries can continue undetected, so that by the time positive detection is obtained, the opportunity for reversal using low-cost preventive measures can be lost.

U.S. Pat. No. 6,522,407 (Everett et al.) discloses the application of polarimetry principles to dental imaging. One system described in the Everett et al. '407 teaching provides a first polarizer in the illumination path for directing a polarized light to the tooth. A second polarizer is provided in the path of reflected light. In one position, the polarizer transmits light of a horizontal polarization. Then, the polarizer is oriented to transmit light having an orthogonal polarization. Intensity of these two polarization states of the reflected light can then be compared to calculate the degree of depolarization of light scattered from the tooth. The result of this comparison then provides information on a detected caries infection.

While the approach disclosed in the Everett et al. '407 patent takes advantage of polarization differences that can result from backscattering of light, the apparatus and methods described therein require the use of multiple polarizers, one in the illumination path, the other in the imaging path. Moreover, the imaging path polarizer must somehow be readily switchable between a reference polarization state and its orthogonal polarization state. Thus, this solution has inherent disadvantages for allowing a reduced package size for caries detection optics. It would be advantageous to provide a simpler solution for caries imaging, a solution not concerned with measuring a degree of depolarization, thus using a smaller number of components and not requiring switchable orientation of a polarizer between one of two positions.

As is described in one embodiment of the Everett et al. '407 patent disclosure, optical coherence tomography (OCT) has been proposed as a tool for dental and periodontal imaging, as well as for other medical imaging applications. For example:
U.S. Patent Application Publication No. 2005/0024646 (Quadling et al.) describes the use of time-domain and Fourier-domain OCT systems for dental imaging;
U.S. Pat. No. 5,570,182 (Nathel et al.) describes the use of OCT for imaging of tooth and gum structures;
U.S. Pat. No. 6,179,611 (Everett et al.) describes a dental explorer tool that is configured to provide a scanned OCT image;
Japanese Patent Application Publication No. JP 2004-344260 (Kunitoshi et al.) discloses an optical diagnostic apparatus equipped with a camera for visual observation of a tooth and use of visible light for a surface image, with OCT apparatus for scanning the indicated region of a surface image by signal light;
U.S. Patent Application Publication No. 2005/0283058 (Choo-Smith et al.) describes a method for combining OCT with Raman spectroscopy; and
U.S. Pat. No. 5,321,501 (Swanson et al.) describes principles of OCT scanning and measurement as used in medical imaging applications.

In addition, a number of published articles describe OCT imaging, including:
“In vivo imaging of hard and soft tissue of the oral cavity” by Feldchtein, et al., available from Optics Express, Vol. 3, No. 6, pp. 239-250, 14 Sep. 1998, discloses the use of OCT using multiple wavelengths;
“Dental OCT” by Colston, Jr. et al., available from Optics Express, Vol. 3, No. 6, pp. 230-238, discloses the use of an OCT scanning system with improved performance and reduced sensitivity to optical birefringence;
“Investigations of soft and hard tissues in oral cavity by Spectral Domain Optical Coherence Tomography” by Madjarova et al. from Coherence Domain Optical Methods and Optical Coherence Tomography in Biomedicine, Processes of SPIE, Vol. 6079 (2006), describes imaging methods for teeth using Fourier domain OCT; and
“Optical Coherence Tomography in Dentistry” by Bill W. Colston Jr. et al. in Handbook of Optical Coherence Tomography edited by Brett E Bouma and Guillermo J. Tearney, pp. 591-612, Marcel Dekker Inc., New York 2002, provides an overview of OCT in dentistry.

While OCT solutions, such as those described above, can provide very detailed imaging of structure beneath the surface of a tooth, OCT imaging itself can be time-consuming and computation-intensive. OCT images would be most valuable if obtained within one or more local regions of interest, rather than obtained over widespread areas. That is, once a dental professional identifies a specific area of interest, then OCT imaging could be directed to that particular area only.

Conventional OCT imaging approaches require the operator to apply the imaging probe to the specific area of the tooth that is to be imaged in order to obtain the OCT image. The operator must solve the problem of correct probe positioning and orientation, which can make it difficult to obtain the OCT scan image that is of most interest.

U.S. Pat. No. 6,868,172 (Boland et al.) describes an image registration method used for aligning and comparing x-ray images taken at different times.

U.S. Patent Application Publication No. 2004/0103101 (Stubler et al.) describes another image registration method for comparing images taken at different times.

U.S. Patent Application Publication No. 2005/0074151 (Chen et al.) describes a method for aligning adjacent images into a video image.

U.S. Pat. No. 6,507,747 (Gowda et al.) describes an optical imaging probe that includes both a spectroscopic imaging probe element and an OCT imaging probe element. This device uses a fluorescence image to guide an OCT scan. However, it does not teach how to select the region for OCT scanning and how to set up and implement the OCT scan.

Thus, it can be seen that there is a need for a method that allows an operator to specify the area of a tooth for OCT scanning and to initiate scanning in a straightforward manner without the need for repositioning the probe for that tooth.

### SUMMARY OF THE INVENTION

The present invention provides a method for obtaining an image of a tooth comprising:
a) obtaining at least one area image of the tooth surface;
b) identifying a region of interest from the at least one area image;
c) positioning a marker on the at least one area image, the marker corresponding to at least a portion of the region of interest;
d) identifying a scanning area; and
e) obtaining an optical coherence tomography (OCT) image over the scanning area.

The use of an operator-positioned marker, positioned relative to the area image to indicate the desired area for OCT scanning, is a feature of the present invention.

The method of the present invention is advantaged over earlier methods for OCT imaging in that it combines the benefits of area imaging for detecting a region of interest and OCT imaging for detailed assessment over that region.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic block diagram of an imaging apparatus for caries detection using a monochrome camera with color filters according to one embodiment;

FIG. 2 is a schematic block diagram of an imaging apparatus for caries detection using a color camera according to an alternate embodiment;

FIG. 3 is a schematic block diagram of an imaging apparatus for caries detection according to an alternate embodiment;

FIG. 4A is a schematic block diagram of an imaging apparatus for caries detection according to an alternate embodiment using polarized light;

FIG. 4B is a schematic block diagram of an imaging apparatus for caries detection according to an alternate embodiment using a polarizing beamsplitter to provide polarized light;

FIG. 5 is a view showing the process for combining dental image data to generate a fluorescence image with reflectance enhancement according to the present invention;

FIG. 6 is a composite view showing the contrast improvement of the present invention in a side-by-side comparison with conventional visual and fluorescence methods;

FIG. 7 is a block diagram showing a sequence of image processing for generating an enhanced threshold image according to one embodiment;

FIG. 8 is a schematic block diagram of an imaging apparatus for caries detection according to an alternate embodiment using multiple light sources

FIG. 9 is a schematic block diagram of an imaging apparatus for caries detection using polarized light in one embodiment of the present invention;

FIG. 10 is a schematic block diagram of an imaging apparatus for caries detection using polarized light in an alternate embodiment of the present invention;

FIG. 11 is a schematic block diagram of an imaging apparatus for caries detection using polarized light in an alternate embodiment of the present invention;

FIG. 12 is a schematic block diagram of an imaging apparatus for caries detection using polarized light from two sources in an alternate embodiment of the present invention;

FIG. 13A is a schematic block diagram of an imaging apparatus for caries detection using polarized light and OCT scanning in one embodiment;

FIG. 13B is a schematic block diagram of an OCT system of the present invention;

FIG. 13C is a schematic block diagram of an imaging apparatus for caries detection using polarized light and OCT scanning in an alternate embodiment;

FIG. 13D is a schematic block diagram of an imaging apparatus for caries detection using polarized light and OCT scanning in a second alternate embodiment;

FIG. 13E is a general schematic block diagram of an imaging system for caries detection combining area imaging and OCT scanning in one embodiment;

FIG. 14A is a plan view of an operator interface screen in one embodiment;

FIG. 14B is an example display of OCT scanning results;

FIG. 15A is a block diagram showing an arrangement of a hand-held imaging apparatus in one embodiment;

FIG. 15B is a block diagram showing an arrangement of a hand-held imaging apparatus in one embodiment combining area imaging with OCT;

FIG. 15C is a block diagram showing an arrangement of a hand-held imaging apparatus in an alternate embodiment;

FIG. 16 is a perspective view showing an imaging apparatus having an integral display;

FIG. 17 is a block diagram showing combination of multiple types of images in order to form a composite reference image;

FIG. 18 is a block diagram showing a wireless dental imaging system in one embodiment;

FIGS. 19A and 19B are plan views showing different types of images that can be displayed to an operator using the apparatus of the present invention;

FIG. 20 is a plan view showing a typical operator interface display according to one embodiment;

FIG. 21A is a plan view showing an embodiment for operator entry of an instruction for OCT scanning of a line;

FIG. 21B is a plan view showing an alternate display arrangement for operator entry of an instruction for OCT scanning of a line;

FIG. 21C is another plan view showing an alternate display arrangement for operator entry of an instruction for OCT scanning of a line;

FIG. 22A is a plan view showing a display arrangement for operator entry of an instruction for OCT scanning of an area;

FIG. 22B is a plan view showing an alternate method for operator entry of a scan instruction for obtaining an OCT scan of an area;

FIG. 23 compares a representative OCT image with a segmented microscopic image of an area along the tooth surface;

FIG. 24 is a cutaway side view diagram showing the use of an index-matching gel according to embodiments of the present invention;

FIG. 25 is a block diagram showing the steps for obtaining an OCT image according to the present invention;

FIG. 26A is a plan view showing the use of an index line for displaying the corresponding OCT data; and

FIG. 26B is a second plan view showing the use of an index line for displaying the corresponding OCT data.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The present invention combines area imaging capabilities for identifying a region or regions of interest on the tooth surface with OCT imaging capabilities for obtaining detailed OCT scan data over a specified portion of the tooth. A region of interest is defined as a region of the tooth which has features indicative of potential caries sites or other defects which would warrant further investigation by OCT imaging. In order to understand the nature and scope of the present invention, it is instructive to first understand its area imaging capabilities. OCT capabilities are then described subsequently. A variety of area imaging embodiments can be combined with an OCT embodiment as described below.

### Area Imaging

As noted in the preceding background section, it is known that fluorescence can be used to detect dental caries using either of two characteristic responses: First, excitation by a blue light source causes healthy tooth tissue to fluoresce in the green spectrum. Secondly, excitation by a red light source can cause bacterial by-products, such as those indicating caries, to fluoresce in the red spectrum.

In order for an understanding of how light is used in the present invention, it is important to give more precise definition to the terms “reflectance” and “backscattering” as they are used in biomedical applications in general and, more particularly, in the method and apparatus of the present invention. In broadest optical parlance, reflectance generally denotes the sum total of both specular reflectance and scattered reflectance. (Specular reflection is that component of the excitation light that is reflected by the tooth surface at the same angle as the incident angle.) In biomedical applications, however, as in the dental application of the present invention, the specular component of reflectance is of no interest and is, instead, generally detrimental to obtaining an image or measurement from a sample. The component of reflectance that is of interest for the present application is from backscattered light only. Specular reflectance must be blocked or otherwise removed from the imaging path. With this distinction in mind, the term “backscattered reflectance” is used in the present application to denote the component of reflectance that is of interest. “Backscattered reflectance” is defined as that component of the excitation light that is elastically backscattered over a wide range of angles by the illuminated tooth structure. “Reflectance image” data, as this term is used in the present invention, refers to image data obtained from backscattered reflectance only, since specular reflectance is blocked or kept to a minimum. In the scientific literature, backscattered reflectance may also be referred to as back reflectance or simply as backscattering. Backscattered reflectance is at the same wavelength as the excitation light.

It has been shown that light scattering properties differ between sound and carious dental regions. In particular, reflectance of light from the illuminated area can be at measurably different levels for normal versus carious areas. This change in reflectance, taken alone, may not be sufficiently pronounced to be of diagnostic value when considered by itself, since this effect is very slight, although detectable. For more advanced stages of caries, for example, backscattered reflectance may be less effective an indicator than at earlier stages.

In conventional fluorescence measurements such as those obtained using QLF techniques, reflectance itself is an effect that is avoided rather than utilized. A filter is usually employed to block off all excitation light from reaching the detection device. For this reason, the slight but perceptible change in backscattered reflectance from excitation light has received little attention for diagnosing caries.

The inventors have found, however, that this backscattered reflectance change can be used in conjunction with the fluorescent effects to more clearly and more accurately pinpoint a carious location. Moreover, the inventors have observed that the change in light scattering activity, while it can generally be detected wherever a caries condition exists, is more pronounced in areas of incipient caries. This backscattered reflectance change is evident at early stages of caries, even when fluorescent effects are least pronounced.

The present invention takes advantage of the observed backscattering behavior for incipient caries and uses this effect, in combination with fluorescence effects described previously in the background section, to provide an improved capability for dental imaging to detect caries. The inventive technique, hereafter referred to as fluorescence imaging with reflectance enhancement (FIRE), not only helps to increase the contrast of images over that of earlier approaches, but also makes it possible to detect incipient caries at stages where preventive measures are likely to effect remineralization, repairing damage done by the caries infection at a stage well before more complex restorative measures are necessary. Advantageously, FIRE detection can be accurate at an earlier stage of caries infection than has been exhibited using existing fluorescence approaches that measure fluorescence alone.

### Imaging Apparatus

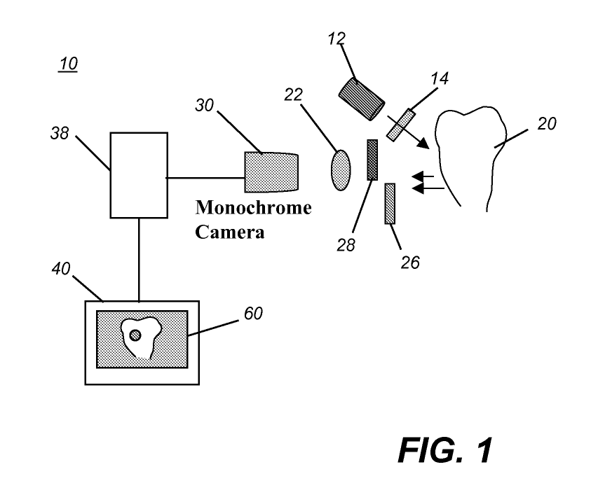

Referring to FIG. 1, there is shown an imaging apparatus 10 for caries detection using the FIRE method in one embodiment. A light source 12 directs an incident light, at a blue wavelength range or other suitable wavelength range, toward tooth 20 through an optional lens 14 or other light beam conditioning component. The tooth 20 may be illuminated at a smooth surface (as shown) or at an occlusal surface (not shown). Two components of light are then detected by a monochrome camera 30 through a field lens 22: a backscattered light component having the same wavelength as the incident light and having measurable reflectance; and a fluorescent emission light component that has been excited due to the incident light on the tooth. For FIRE imaging, specular reflection causes false positives and is undesirable. To minimize specular reflection pick up, the camera 30 is positioned at a suitable angle with respect to the light source 12. This allows imaging of backscattered light without the confounding influence of a specularly reflected component.

In the embodiment of FIG. 1, monochrome camera 30 has color filters 26 and 28. One of color filters 26 and 28 is used during reflectance imaging; the other is used during fluorescence imaging. A processing apparatus 38 obtains and processes the reflectance and fluorescence image data and forms a FIRE image 60. FIRE image 60 is an enhanced diagnostic image that can be printed or can appear on a display 40. FIRE image 60 data can also be transmitted to storage or transmitted to another site for display. The FIRE image data is an example of processed image data from an area image of a tooth.

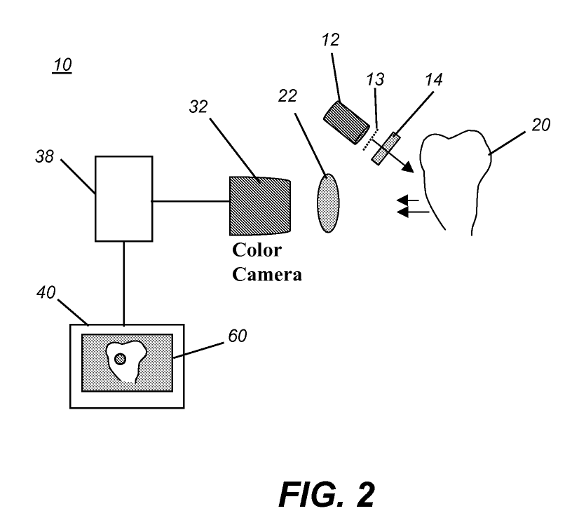

Referring to FIG. 2, there is shown an alternate embodiment using a color camera 32. With this arrangement, auxiliary filters would not generally be needed, since color camera 32 would be able to obtain the reflectance and fluorescence images from the color separations of the full color image of tooth 20.

Light source 12 is typically centered around a blue wavelength, such as about 405 nm in one embodiment. In practice, light source 12 could emit light ranging in wavelength from an upper ultraviolet range to blue, between about 300 and 500 nm. Light source 12 can be a laser or could be fabricated using one or more light emitting diodes (LEDs). Alternately, a broadband source, such as a xenon lamp, having a supporting color filter for passing the desired wavelengths could be used. Lens 14 or other optical element may serve to condition the incident light, such as by controlling the uniformity and size of the illumination area. For example, a diffuser 13, shown as a dotted line in FIG. 2, might be used before or after lens 14 to smooth out the hot spots of an LED beam. The path of illumination light might include light guiding or light distributing structures such as an optical fiber or a liquid light guide, for example (not shown). Light level is typically a few milliwatts in intensity, but can be more or less, depending on the light conditioning and sensing components used.

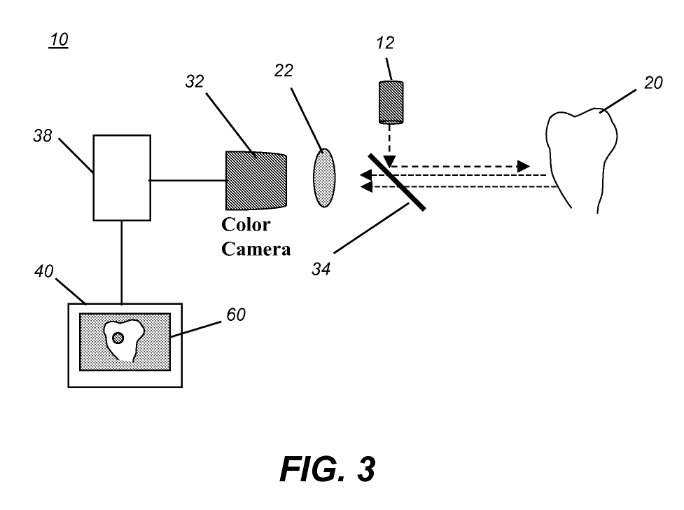

Referring to FIG. 3, the illumination arrangement could alternately direct light at normal incidence, turned through a beamsplitter 34. Camera 32 would then be disposed to obtain the image light that is transmitted through beamsplitter 34. Other options for illumination include multiple light sources directed at the tooth with angular incidence from one or more sides. Alternately, the illumination might use an annular ring or an arrangement of LED sources distributed about a center such as in a circular array to provide light uniformly from multiple angles. Illumination could also be provided through an optical fiber or fiber array.

The imaging optics, represented as field lens 22 in FIGS. 1-3, could include any suitable arrangement of optical components, with possible configurations ranging from a single lens component to a multi-element lens. Clear imaging of the tooth surface, which is not flat but can have areas that are both smoothly contoured and highly ridged, requires that imaging optics have sufficient depth of focus. Preferably, for optimal resolution, the imaging optics provide an image size that substantially fills the sensor element of the camera. The use of telecentric optics is advantaged for field lens 22, providing image-bearing light that is not highly dependent on ray angle.

Image capture can be performed by either monochrome camera 30 (FIG. 1) or color camera 32 (FIG. 2). Typically, camera 30 or 32 employs a CMOS or CCD sensor. The monochrome version would typically employ a retractable spectral filter 26, 28 suitable for the wavelength of interest. For light source 12 having a blue wavelength, spectral filter 26 for capturing reflectance image data would transmit predominately blue light. Spectral filter 28 for capturing fluorescence image data would transmit light at a different wavelength, such as predominately green light. Preferably, spectral filters 26 and 28 are automatically switched into place to allow capture of both reflectance and fluorescence images in very close succession. Both images are obtained from the same position to allow accurate registration of the image data.

Spectral filter 28 would be optimized with a pass-band that captures fluorescence data over a range of suitable wavelengths. The fluorescent effect that has been obtained from tooth 20 can have a relative broad spectral distribution in the visible range, with light emitted that is outside the wavelength range of the light used for excitation. The fluorescent emission is typically between about 450 nm and 600 nm, while generally peaking in the green region, roughly from around 510 nm to about 550 nm. Thus a green light filter is generally preferred for spectral filter 28 in order to obtain this fluorescence image at its highest energy levels. With color camera 32, the green image data is generally used for this same reason. This green image data is also obtained through a green light filter, such as a green filter in a color filter array (CFA), as is well known to those skilled in the color image capture art. However, other ranges of the visible spectrum could also be used in other embodiments.

Camera controls are suitably adjusted for obtaining each type of image. For example, when capturing the fluorescence image, it is necessary to make appropriate exposure adjustments for gain, shutter speed, and aperture, since this image may not be intense. When using color camera 32 (FIG. 2), color filtering is performed by the color filter arrays on the camera image sensor. The reflectance image is captured in the blue color plane; simultaneously, the fluorescence image is captured in the green color plane. That is, a single exposure captures both backscattered reflectance and fluorescence images.

Processing apparatus 38 is typically a computer workstation but may, in its broadest application, be any type of control logic processing component or system that is capable of obtaining image data from camera 30 or 32 and executing image processing algorithms upon that data to generate the FIRE image 60 data. Processing apparatus 38 may be local or may connect to image sensing components over a networked interface.

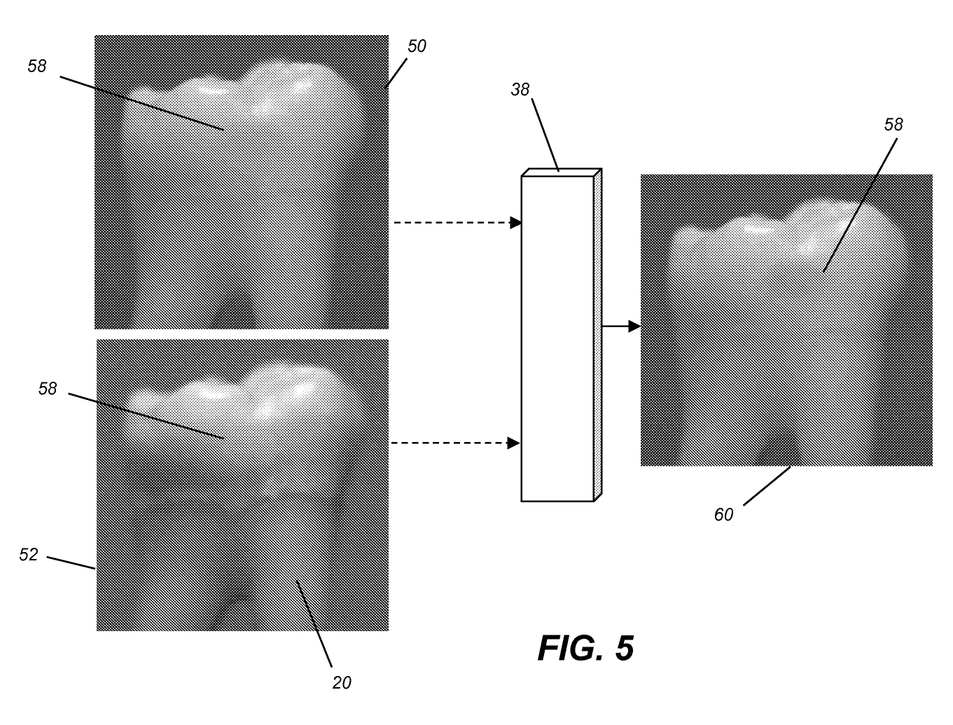

Referring to FIG. 5, there is shown, in schematic form, how the FIRE image 60 is formed according to the present invention. Two area images of tooth 20 are obtained, a green fluorescence image 50 and a blue reflectance image 52. As noted earlier, it must be emphasized that the reflectance light used for reflectance image 52 and its data is from backscattered reflectance, with specular reflectance blocked or kept as low as possible. In the example of FIG. 5, there is a carious region 58, represented in phantom outline in each of images 50, 52, and 60, which causes a slight decrease in fluorescence and a slight increase in reflectance. The carious region 58 may be imperceptible or barely perceptible in either fluorescence image 50 or reflectance image 52, taken individually. Both the green fluorescence image 50 and the blue reflectance image 52 area images appear as if all the features of interest are on the surface of the tooth. This is due to the fact that there is no depth information inherent in either technique. Even though the carious region 58 has a physical penetration depth it appears to be coming from the surface only. Thus the area image appears as if it is an image of the observed tooth surface. Processing apparatus 38 operates upon the image data using an image processing algorithm as discussed below for both images 50 and 52 and provides FIRE image 60 as a result. The contrast between carious region 58 and sound tooth structure is heightened, so that a caries condition is made more visible in FIRE image 60.

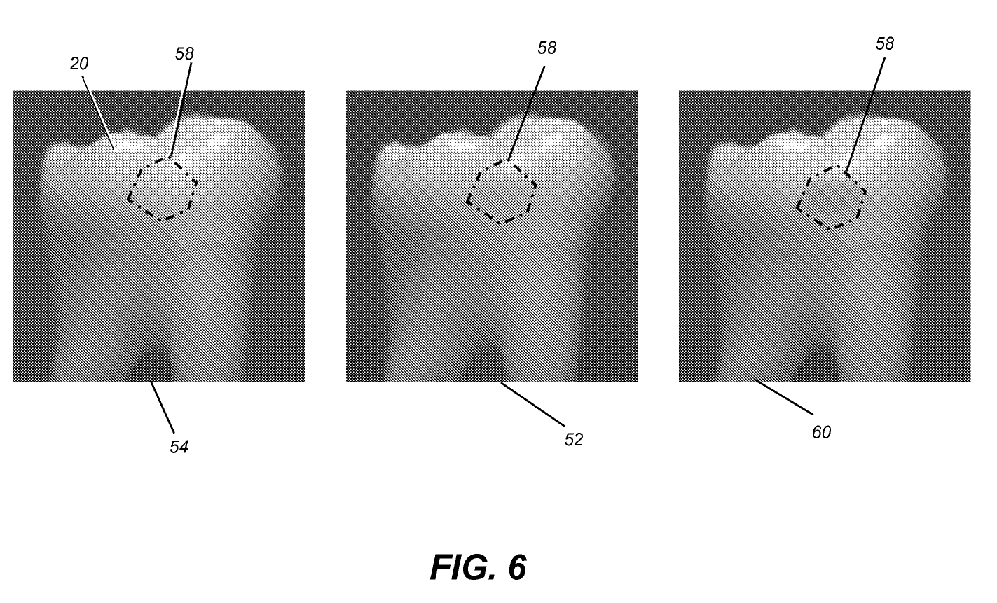

FIG. 6 shows the contrast improvement of the present invention in a side-by-side comparison with a visual white-light image 54 and conventional fluorescence methods. For caries at a very early stage, the carious region 58 may look indistinct from the surrounding healthy tooth structure in white-light image 54, either as perceived directly by eye or as captured by an intraoral camera. In the green fluorescence image 52 captured by existing fluorescence method, the carious region 58 may show up as a very faint, hardly noticeable shadow. In contrast, in the FIRE image 60 generated by the present invention, the same carious region 58 shows up as a darker, more detectable spot. Clearly, the FIRE image 60, with its contrast enhancement, offers greater diagnostic value. The outlined carious region 58 is an example of a region of interest as used in carrying out this invention. It can either be defined by the operator or automatically determined by image processing.

### Image Processing

As described earlier with reference to FIGS. 5 and 6, processing of the image data uses both the reflectance and fluorescence image data to generate a final image that can be used to identify carious areas of the tooth. There are a number of alternative processing methods for combining the reflectance and fluorescence image data to form FIRE image 60 for diagnosis. In one embodiment, this image processing performs the following operation for each pixel:

(m*Fᵥₐₗᵤₑ)−(n*Rᵥₐₗᵤₑ) (1)

where m and n are suitable multipliers (positive coefficients) and Fᵥₐₗᵤₑ and Rᵥₐₗᵤₑ are the code values obtained from fluorescence and reflectance image data, respectively.

Backscattered reflectance is higher (brighter) for image pixels in the carious region, yielding a higher reflectance value Rᵥₐₗᵤₑ for these pixels than for surrounding pixels. The fluorescence, meanwhile, is lower (darker) for image pixels in the carious region, yielding a lower fluorescence value Fᵥₐₗᵤₑ for these pixels than for surrounding pixels. For a pixel in a carious region, the fluorescence is considerably weaker in intensity compared to the reflectance. After multiplying the fluorescence and reflectance by appropriate scalar multipliers m and n, respectively, where m>n, the scaled fluorescence values of all pixels are made to exceed or equal to the corresponding scaled reflectance values:

(m*Fᵥₐₗᵤₑ)>or=(n*Rᵥₐₗᵤₑ). (2)

Subtraction of the scaled backscattered reflectance value from the scaled fluorescence value for each pixel then results in a processed image where the contrast between the intensity values for pixels in the carious region and pixels in sound region is accentuated, resulting in a contrast enhancement that can be readily displayed and recognized. In one embodiment, scalar multiplier n for reflectance value Rᵥₐₗᵤₑ is one.

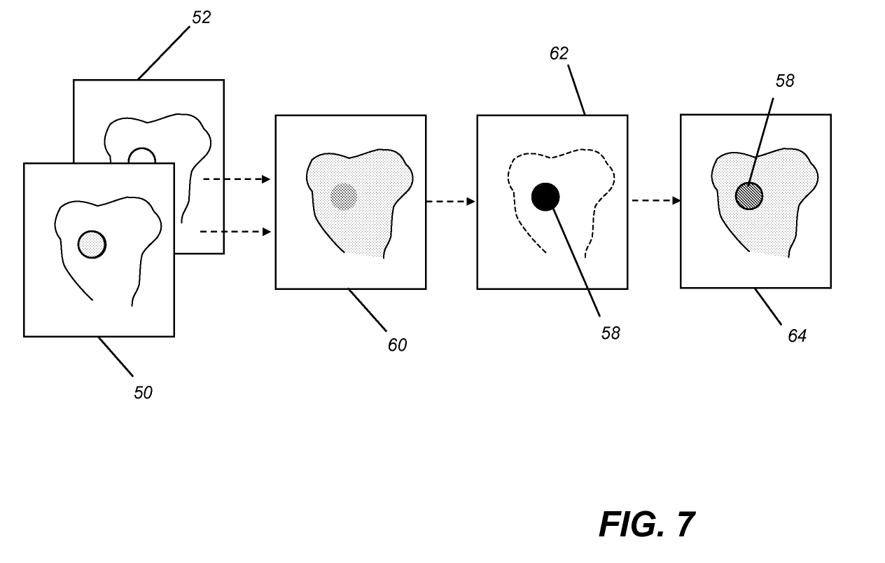

Following an initial combination of fluorescence and reflectance values as given earlier with reference to the example of expression (1), additional image processing may also be of benefit. A thresholding operation, executed using image processing techniques familiar to those skilled in the imaging arts, or some other suitable conditioning of the combined image data used for FIRE image 60, may be used to further enhance the contrast between a carious region and sound tooth structure. Referring to FIG. 7, there is shown, in block diagram form, a sequence of image processing for generating an enhanced threshold FIRE image 64 according to one embodiment. Fluorescence image 50 and reflectance image 52 are first combined to form FIRE image 60, as described previously. A thresholding operation is next performed, providing threshold image 62 that defines more clearly the area of interest, carious region 58. Then, threshold image 62 is combined with original FIRE image 60 to generate enhanced threshold FIRE image 64. Similarly, the results of threshold detection can also be superimposed onto a white light image 54 (FIG. 6) in order to definitively outline the location of a carious infection.

The choice of appropriate coefficients m and n is dependent on the spectral content of the light source and the spectral response of the image capture system. There is variability in the center wavelength and spectral bandwidth from one LED to the next, for example. Similarly, variability exits in the spectral responses of the color filters and image sensors of different image capture systems. Such variations affect the relative magnitudes of the measured reflectance and fluorescence values. Therefore, it may be necessary to determine a different m and n value for each imaging apparatus 10 as a part of an initial calibration process. A calibration procedure used during the manufacturing of imaging apparatus 10 can then optimize the m and n values to provide the best possible contrast enhancement in the FIRE image that is formed.

In one calibration sequence, a spectral measurement of the light source 12 used for reflectance imaging is obtained. Then, spectral measurement is made of the fluorescent emission that is excited from the tooth. This data provides a profile of the relative amount of light energy available over each wavelength range of interest. Then the spectral response of camera 30 (with appropriate filters) or 32 is quantified against a known reference. These data are then used, for example, to generate a set of optimized multiplier m and n values to be used by processing apparatus 38 of the particular imaging apparatus 10 for forming FIRE image 60.

It can be readily appreciated that any number of more complex image processing algorithms could alternately be used for combining the reflectance and fluorescence image data in order to obtain an enhanced image that identifies carious regions more clearly. It may be advantageous to apply a number of different imaging algorithms to the image data in order to obtain the most useful result. In one embodiment, an operator can elect to use any of a set of different image processing algorithms for conditioning the fluorescence and reflectance image data obtained. This would allow the operator to check the image data when processed in a number of different ways and may be helpful for optimizing the detection of carious lesions having different shape-related characteristics or that occur over different areas of the tooth surface.

It is emphasized that the image contrast enhancement achieved in the present invention, because it employs both reflectance and fluorescence data, is advantaged over conventional methods that use fluorescent image data only. Conventionally, where only fluorescence data is obtained, image processing has been employed to optimize the data, such as to transform fluorescence data based on spectral response of the camera or of camera filters or other suitable characteristics. For example, the method of the '2356 Stookey et al. disclosure, cited above, performs this type of optimization, transforming fluorescence image data based on camera response. However, these conventional approaches overlook the added advantage of additional image information that the backscattered reflectance data obtains.

### Alternate Embodiments

The method of the present invention admits a number of alternate embodiments. For example, the contrast of either or both of the reflectance and fluorescence images may be improved by the use of a polarizing element. It has been observed that enamel, having a highly structured composition, is sensitive to the polarization of incident light. Polarized light has been used to improve the sensitivity of dental imaging techniques, for example, in “Imaging Caries Lesions and Lesion Progression with Polarization Sensitive Optical Coherence Tomography” in J. Biomed Opt., October 2002; 7(4): pp. 618-27, by Fried et al.

Specular reflection tends to preserve the polarization state of the incident light. For example, where the incident light is S-polarized, the specular reflected light is also S-polarized. Backscattering, on the other hand, tends to de-polarize or randomize the polarization of the incident light. Where incident light is S-polarized, backscattered light has both S- and P-polarization components. Using a polarizer and analyzer, this difference in polarization handling can be employed to help eliminate unwanted specular reflectance from the reflectance image, so that only backscattered reflectance is obtained.

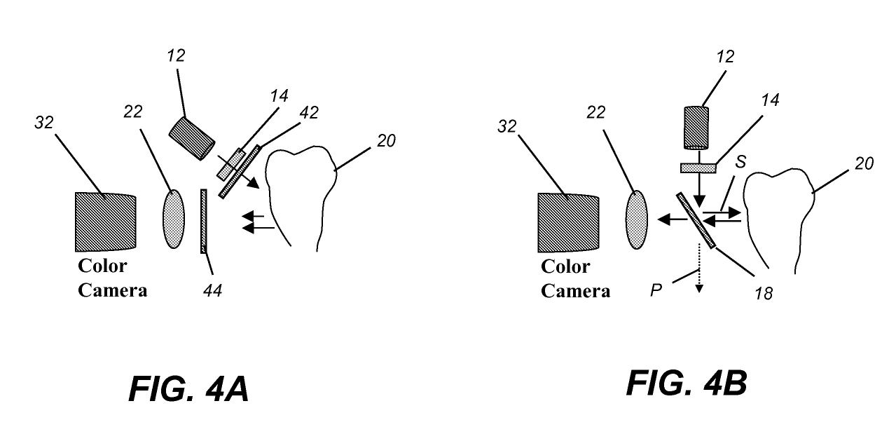

Referring to FIG. 4A, there is shown an embodiment of imaging apparatus 10 that employs a polarizer 42 in the path of illumination light. Polarizer 42 passes linearly polarized incident light. An optional analyzer 44 may also be provided in the path of image-bearing light from tooth 20 as a means to minimize the specular reflectance component. With this polarizer 42/analyzer 44 combination as polarizing elements, reflectance light sensed by camera 30 or 32 is predominantly backscattered light, that portion of the reflectance that is desirable for combination with the fluorescence image data according to the present invention.

An alternate embodiment, shown in FIG. 4B, employs a polarizing beamsplitter 18 (sometimes termed a polarization beamsplitter) as a polarizing element. In this arrangement, polarizing beamsplitter 18 advantageously performs the functions of both the polarizer and the analyzer for image-bearing light, thus offering a more compact solution. Tracing the path of illumination and image-bearing light shows how polarizing beamsplitter 18 performs this function. Illumination from light source 12 is essentially unpolarized. Polarizing beamsplitter 18 transmits P-polarization, as shown by the dotted arrow in FIG. 4B, and reflects S-polarization, directing this light to tooth 20. At a caries infection site, backscattering depolarizes this light. Polarizing beamsplitter 18 treats the backscattered light in the same manner, transmitting the P-polarization and reflecting the S-polarization. The resulting P-polarized light can then be detected at camera 30 (with suitable filter as was described with reference to FIG. 1) or color camera 32. Because specular reflected light is S-polarized, polarizing beamsplitter 18 effectively removes this specular reflective component from the light that reaches camera 30, 32.

Polarized illumination results in further improvement in image contrast, but at the expense of light level, as can be seen from the description of FIGS. 4A and 4B. Hence, when using polarized light in this way, it may be necessary to employ a higher intensity light source 12. This employment of polarized illumination is particularly advantaged for obtaining the reflectance image data and is also advantaged when obtaining the fluorescence image data, increasing image contrast and minimizing the effects of specular reflection.

One type of polarizer 42 that has particular advantages for use in imaging apparatus 10 is the wire grid polarizer, such as those available from Moxtek Inc. of Orem, Utah and described in U.S. Pat. No. 6,122,103 (Perkins et al.) The wire grid polarizer exhibits good angular and color response, with relatively good transmission over the blue spectral range. Either or both polarizer 42 and analyzer 44 in the configuration of FIG. 4A could be wire grid polarizers. Wire grid polarizing beamsplitters are also available, and can be used in the configuration of FIG. 4B.

The method of the present invention takes advantage of the way the tooth tissue responds to incident light of sufficient intensity, using the combination of fluorescence and light reflectance to indicate carious areas of the tooth with improved accuracy and clarity. In this way, the present invention offers an improvement upon existing non-invasive fluorescence detection techniques for caries. As was described in the background section given above, images that have been obtained using fluorescence only may not clearly show caries due to low contrast. The method of the present invention provides images having improved contrast and is, therefore, of more potential benefit to the diagnostician for identifying caries.

In addition, unlike earlier approaches using fluorescence alone, the method of the present invention also provides images that can be used to detect caries in its very early incipient stages. This added capability, made possible because of the perceptible backscattering effects for very early carious lesions, extends the usefulness of the fluorescence technique and helps in detecting caries during its reversible stages, so that fillings or other restorative strategies might not be needed.

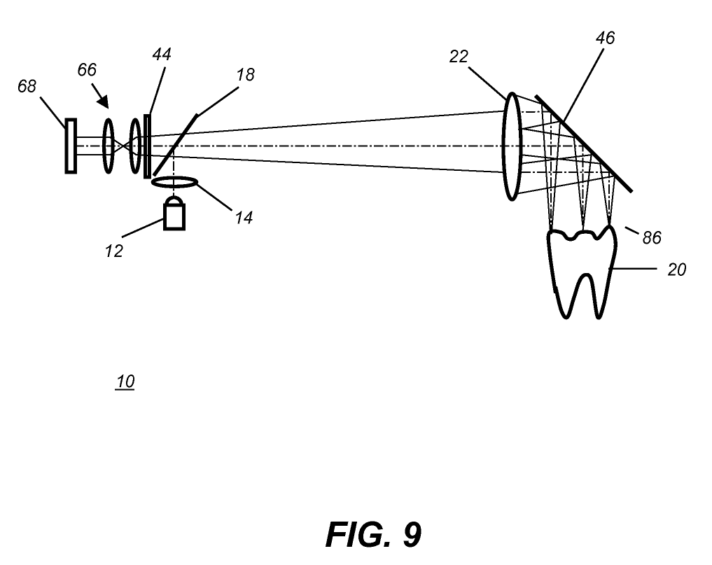

Referring to FIG. 9, there is shown an embodiment of imaging apparatus 10 using polarized light from a polarizing beamsplitter 18 and using a telecentric field lens 22. Light source 12, typically a light source in the blue wavelength range for exciting maximum fluorescence from tooth 20 provides illumination through lens 14 and onto polarizing beamsplitter 18. Here, one polarization state transmits, the other is reflected. In a typical embodiment, S-polarized light is transmitted through polarizing beamsplitter 18 and is, therefore, discarded. The P-polarized light is reflected toward tooth 20 at an aperture 86, guided by field lens 22 and an optional turning mirror 46 or other reflective surface. Light returning from tooth 20 can include a specular reflection component and a backscattered reflection component. Specular reflectance does not change the polarization state. Thus, for the P-polarized illumination, that is, for the unwanted specularly reflected component, the reflected light is directed back toward light source 12. As has been observed, backscattered reflectance undergoes some amount of depolarization. Thus, some of the backscattered reflected light has S-polarization and is transmitted through polarizing beamsplitter 18. This returning light may be further conditioned by optional analyzer 44 and then directed by an imaging lens 66 to sensor 68, such as a camera. In this way, the returning light directed to sensor 68 is the backscattered reflectance component only; the spectral reflectance component is removed from the imaging optics path.

The use of telecentric field lens 22 is advantaged in the embodiments of FIG. 9 and following. Telecentric optics provide a good field of view and substantially constant magnification within the working distance of the optics, which is particularly useful for highly contoured structures such as teeth that are imaged at a short distance. Perspective distortion is minimized. Telecentric field lens 22 is a multi-element lens, represented by a single lens symbol in FIG. 9 and following. Light source 12 may be any suitable color, including blue, white, or red, for example. Preferably, field lens 22 is telecentric in both image space and object space.

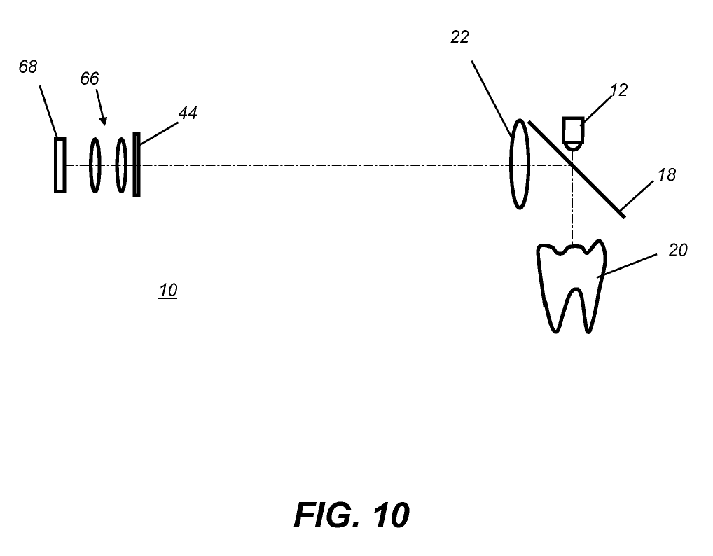

FIG. 10 shows an alternate embodiment of imaging apparatus 10 in which no turning mirror is used. Instead, polarizing beamsplitter 18 is disposed in the imaging path between field lens 22 and tooth 20. Light source 12 is positioned to direct illumination through polarizing beamsplitter 18, so that the illumination effectively bypasses field lens 22. Specularly reflected light is again discarded by means of polarizing beamsplitter 18 and analyzer 44.

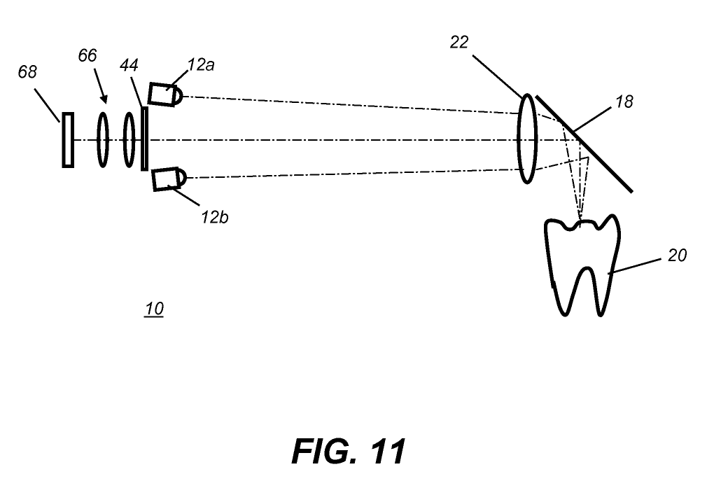

The block diagram of FIG. 11 shows an alternate embodiment of imaging apparatus 10 in which two separate light sources 12a and 12b are used. Light sources 12a and 12b may both emit the same wavelengths or may emit different wavelengths. They may illuminate tooth 20 simultaneously or one at a time. Polarizing beamsplitter 18 is disposed in the imaging path between field lens 22 and tooth 20, thus providing both turning and polarization functions.

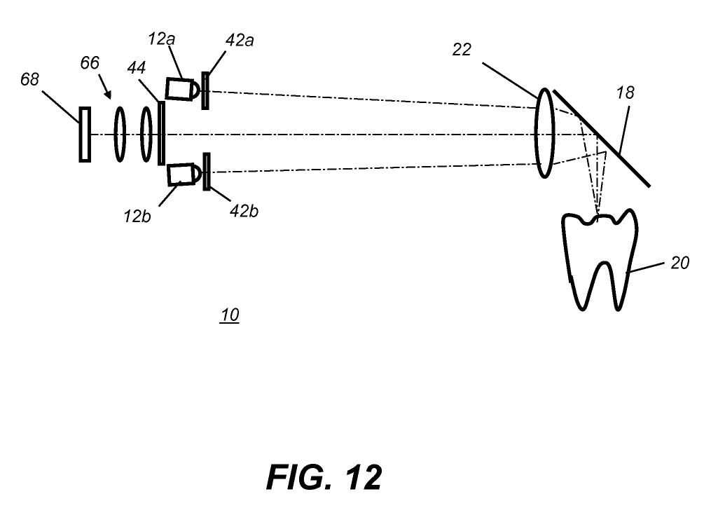

FIG. 12 shows another alternate embodiment, similar to that shown in FIG. 11, in which each of light sources 12a and 12b has a corresponding polarizer 42a and 42b. A turning mirror could be substituted for polarizing beamsplitter 18 in this embodiment; however, the use of both polarized illumination, as provided from the combination of light sources 12a and 12b and their corresponding polarizers 42a and 42b, and polarizing beamsplitter 18 can be advantageous for improving image quality.

### Embodiments Using Optical Coherence Tomography (OCT)

Optical coherence tomography (OCT) is a non-invasive imaging technique that employs interferometric principles to obtain high resolution, cross-sectional tomographic images of internal microstructures of the tooth and other tissue that cannot be obtained using conventional imaging techniques. Due to differences in the backscattering from carious and healthy dental enamel OCT can determine the depth of penetration of the caries into the tooth and determine if it has reached the dentin enamel junction. From area OCT data it is possible to quantify the size, shape, depth and determine the volume of carious regions in a tooth.

In an OCT imaging system for living tissue, light from a low-coherence source, such as an LED or other light source, can be used. This light is directed down two different optical paths: a reference arm of known length and a sample arm, which goes to the tooth. Reflected light from both reference and sample arms is then recombined, and interference effects are used to determine characteristics of the underlying features of the sample. Interference effects occur when the optical path lengths of the reference and sample arms are equal within the coherence length of the light source. As the path length difference between the reference arm and the sample arm is changed the depth of penetration in the sample is modified in a similar manner. Typically in biological tissues NIR light of around 1300 nm can penetrate about 3-4 mm as is the case with dental tissue. In a time domain OCT system the reference arm delay path relative to the sample arm delay path is alternately increased monotonically and decreased monotonically to create depth scans at a high rate. To create a 2-dimensional scan the sample measurement location is changed in a linear manner during repetitive depth scans.

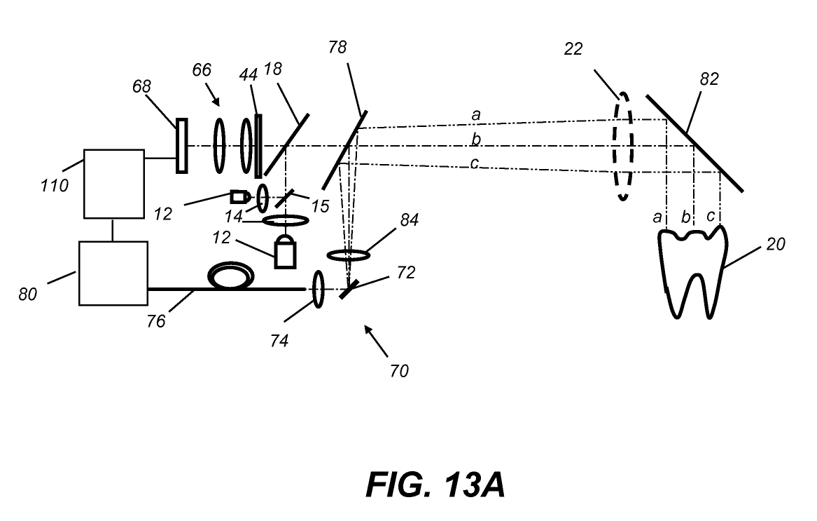

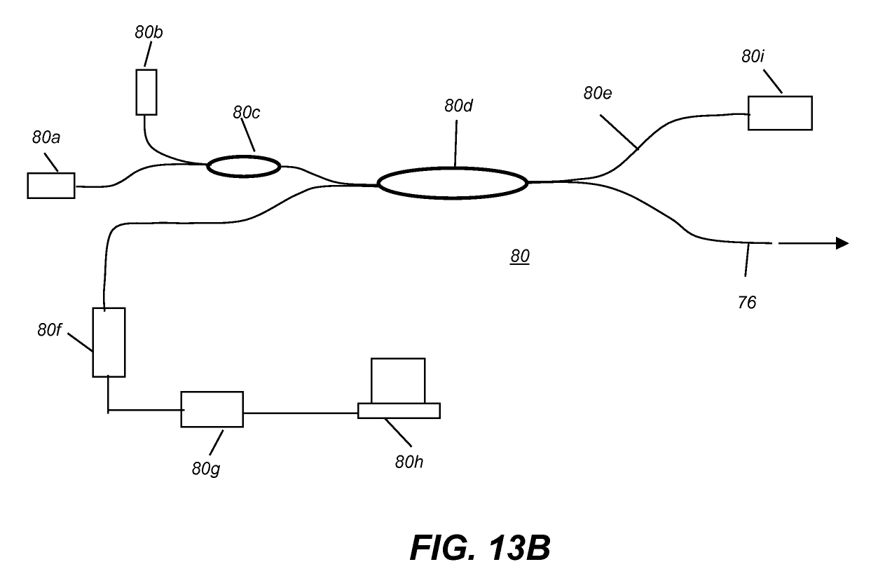

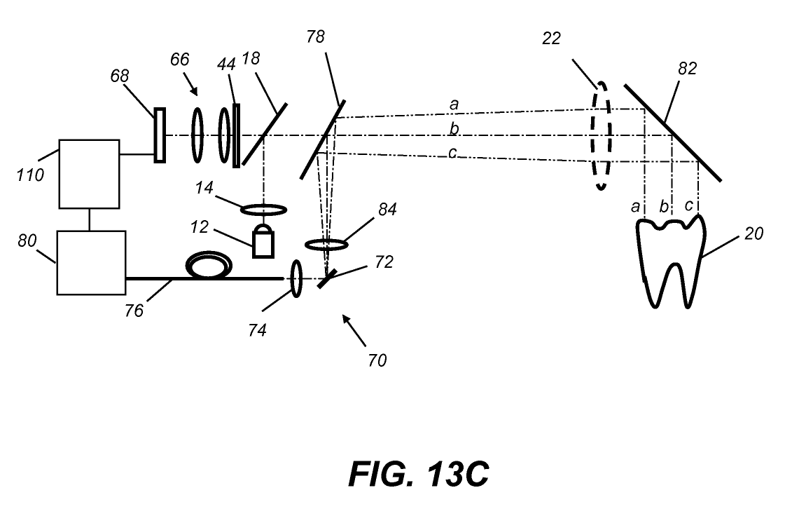

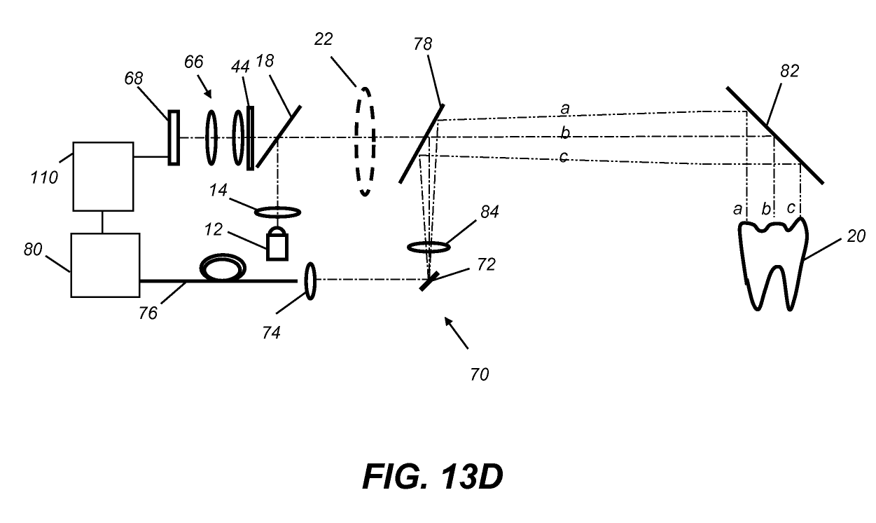

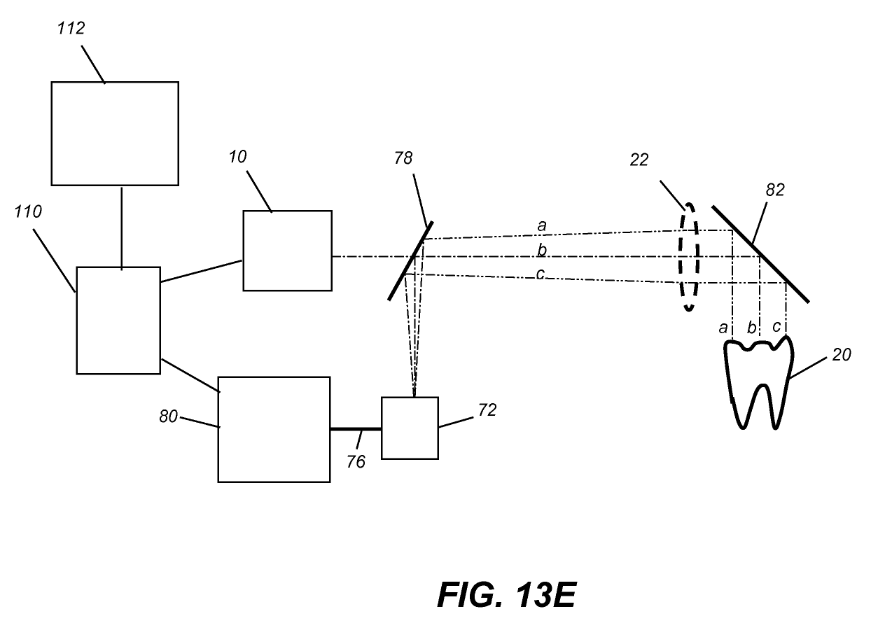

Referring to FIG. 13A, there is shown an embodiment of imaging apparatus 10 using both FIRE imaging methods and OCT imaging. Light sources 12, lenses 14, light source combiner 15, polarizing beamsplitter 18, optional field lens 22, turning mirror 82, analyzer 44, imaging lens 66, and sensor 68 act as an area imaging optical system and provide the FIRE area imaging function as described previously. Referring to FIG. 13C is shown an alternate embodiment of the imaging apparatus 10 using both FIRE imaging methods and OCT imaging in which only one light source 12 and lens 14 are present and the light source combiner 15 is not needed. Referring to FIG. 13D is shown a second alternate embodiment of the imaging apparatus 10 using both FIRE imaging methods and OCT imaging in which the field lens 22 is only used in the FIRE apparatus and is not in the OCT imaging path.

The FIRE area imaging works in combination with an OCT imaging optical system as described in the following. An OCT imager 70 directs light for OCT scanning into the optical path that is shared with the FIRE imaging components. Light from an OCT system 80 is directed through a sample arm optical fiber 76 and through a collimating lens 74 to a scanning element 72, such as a galvanometer or a MEMS scanning device. The scanning element 72 can have 1 or preferably 2 axes, only one is shown. Light reflecting from the scanning element 72 passes through a scanning lens 84 and is incident onto a dichroic filter 78. The dichroic filter 78 is designed to be transmissive to visible light and reflective for near-IR and longer wavelengths. This sample arm light is then reflected from dichroic filter 78 to tooth 20 through optional field lens 22 and turning mirror 82. Scattered and reflected light returning from tooth 20 travels down the same optical path in reverse direction and is recombined with light from the reference arm (not shown) of OCT system 80. The multiple dashed lines labeled a,b and c starting from scanning element 72 represent scan positions at different times during a single line scan and show that they are incident on and reflect from different locations of the tooth as shown in FIG. 13A. The position of the scanning element is computer controlled by control circuitry and/or computer system 110. In general the processing apparatus 38 shown in FIG. 5 can be incorporated into control circuitry and/or computer system 110. The maximum distance of travel along any axis is determined by the usable aperture of the lens 84. Usually raster scan are performed along a desired axis with increments in the perpendicular axis.

The FIRE data and OCT data are processed and controlled by control circuitry and/or computer 110 and displayed on display 112.

FIG. 13B shows a diagram of the components of an example OCT system 80, which can be a time-domain or a Fourier-domain system. Light provided by OCT light source 80a can be a continuous wave low coherence or broadband light, and may be from a source such as a super-luminescent diode (SLD), diode-pumped solid-state crystal source, or diode-pumped rare earth-doped fiber source, for example. In one embodiment, near-IR light is used, such as light having wavelengths near 1310 nm, for example. Usually OCT light source 80a has the wavelength in near-infrared (NIR), for example, at around 1310 nm, in order to obtain enough depth inside the object under investigation. Alternatively the light source 80a can operate at around 850 nm. When working with a Fourier Domain instrument the OCT light source 80a can be a tunable laser diode. Optional visible light source 80b, at a different wavelength than light source 80a, aids in OCT scan visualization. This is useful to show where the OCT light is scanning on the tooth surface during line or area scans so that the practitioner can see where they are actually performing measurements. Light source 80b can be a visible laser or laser diode, LED, or other light source at, for example centered on 650 nm. A 2-to-1 coupler 80c combines the light from light sources 80a and 80b and sends the light to a 2 by 2 coupler 80d, which also acts as the active element of the interferometer. After passing coupler 80d, the light from light sources 80a and 80b separates into a reference arm optical fiber 80e and a sample arm optical fiber 76. Light traveling down the reference arm optical fiber 80e is incident upon the reference delay depth scanner 80i. The purpose of the reference delay depth scanner, 80i is to change the path length of the reference arm of the interferometer relative to the sample arm. The reference delay depth scanner 80i includes a reflector (not shown), which causes the delayed light to travel back down reference arm optical fiber 80e. The light signals returned from reference and sample arms are recombined by 2 by 2 coupler 80d to form the interference signal. The interferometric is detected by detector and detection electronics 80f as a function of time. The detected signal is collected by a control logic processor 80h after processing though signal processing electronics 80g, for example, low pass filter and logarithm of the envelope of the interference signal amplifier. The detector 80f can either be a balanced detector or a single ended photodetector. If a balanced detector is used there is usually an optical circulator added to the OCT system 80 between elements 80c and 80d.

Many alternative configurations are possible for the OCT system 80. In order to increase the depth scanning capability and maintaining a high frequency of operation it can be desirable to have a depth scanning element in the sample arm as well as in the reference arm. The mechanism of operation of the reference delay depth scanner can be based on linear translation of retroreflective elements, varying the optical pathlength by rotational methods, use of piezoelectric driven fiber optic stretchers or based on group delay generation using Fourier Domain optical pulse shaping technology such as a Fourier Domain Rapid Scanning optical delay line. Many of these reference delay scanning alternatives are described in “Reference Optical Delay Scanning” by Andrew Rollins and Joseph Izatt in Handbook of Optical Coherence Tomography edited by Brett E Bouma and Guillermo J. Tearney, pp. 99-123, Marcel Dekker Inc. New York 2002.

Reference delay depth scanner 80i is used for a time-domain system. For a Fourier Domain OCT system, light source 80a can be either a broadband low-coherence super-luminescent diode (SLD), or a tunable light source. When the light source is an LED, detector and detection electronics 80f is an array of sensing elements in order to obtain the depth information. When a tunable light source is used, detector and detection electronics 80f includes a point detector; the depth information is obtained by tuning the wavelength of light source 80a and taking the Fourier transform of the data obtained as a function of wavelength.

FIG. 13E is a general schematic block diagram of an imaging system for caries detection combining area imaging and OCT scanning according to the present invention. Here any configuration of imaging apparatus 10 can be incorporated into the system with any OCT scanning element 72 connecting to OCT system 80 by sample arm optical fiber 76. Dichroic filter 78 combines the light coming from imaging apparatus 10 with the light coming from the OCT system 80 as described in the discussion of FIG. 13A above. Data is processed and the system is controlled by computer 110. The data is displayed on display 112.

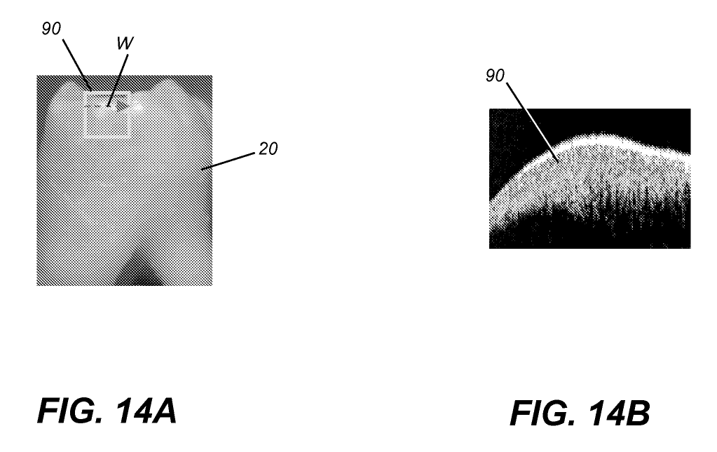

While the OCT scan is a particularly powerful tool for helping to show the condition of the tooth beneath the surface, it can be appreciated that this type of detailed information is not needed for every tooth. Instead, it would be advantageous to be able to identify specific areas of interest and apply OCT imaging to just those areas. Referring to FIG. 14A, there is shown a display of an area image of tooth 20. The area image can be selected from the group including white light, reflectance, trans-illumination, fluorescence, x-ray or a processed image obtained from combining one or more of the above image types. An area of interest 90 can be identified by a diagnostician for scanning. As is described subsequently, using operator interface tools at processing apparatus 38 and display 40 (FIGS. 1-3), an operator can outline area of interest 90 on display 40. The OCT scans over the region of interest can then be performed. Referring to FIG. 14B, there is shown a typical OCT display of a line scan shown by the dotted arrow W in FIG. 14A inside the area of interest 90 in one embodiment. The OCT data shown in FIG. 14B is a single line scan of multiple fast depth scans within the region of interest. The vertical axis in the OCT data shown in FIG. 14B is depth and the horizontal axis is distance along the dotted arrow shown in FIG. 14A. The horizontal axis scan is created by the scanning element 72 as it performs a single line scan. The OCT scan is shown as a grey scale representing the intensity of the detected log envelope signal with white being the most scattering and black being the lowest return signal level. The data shown in FIG. 14B consists of 1000 points per depth scan (vertical axis, 3 mm total distance) and 280 points (70 points per mm) along the horizontal line scan direction. The top contour in FIG. 14B corresponds to the contour of the surface of the tooth. The height of the scattering region at each horizontal location of the tooth region shown in FIG. 14B is related to the health of the tissue in the tooth at each lateral location. In general the scattering penetrates deeper in carious tissue than in normal tissue. Multiple line scans can be performed in a raster scan pattern to map out the entire region of interest shown in FIG. 14B. From the depth of penetration as a function of position the volume of the carious region can be mapped out.

### Probe Embodiments

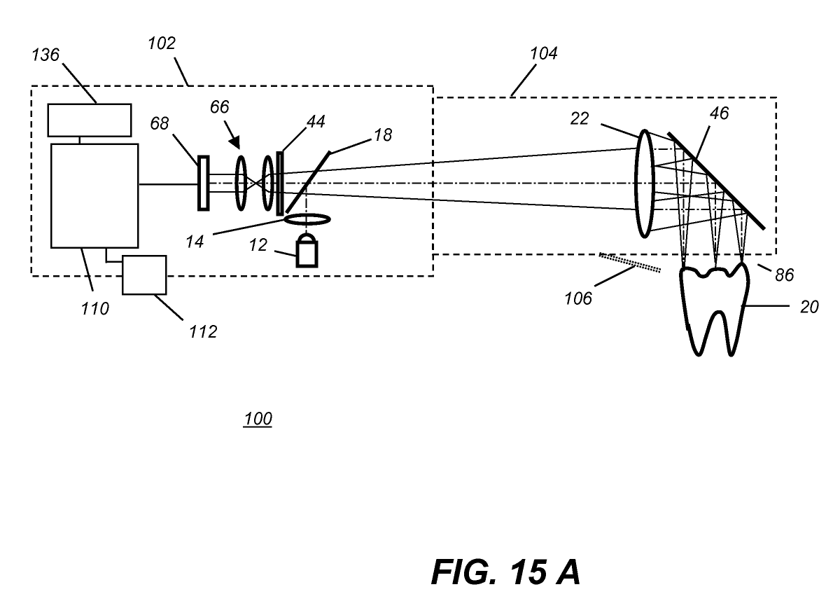

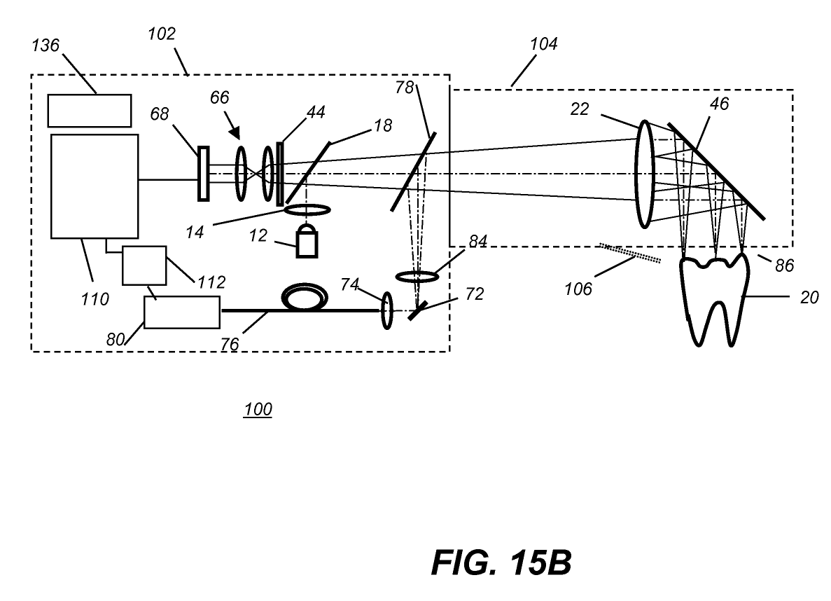

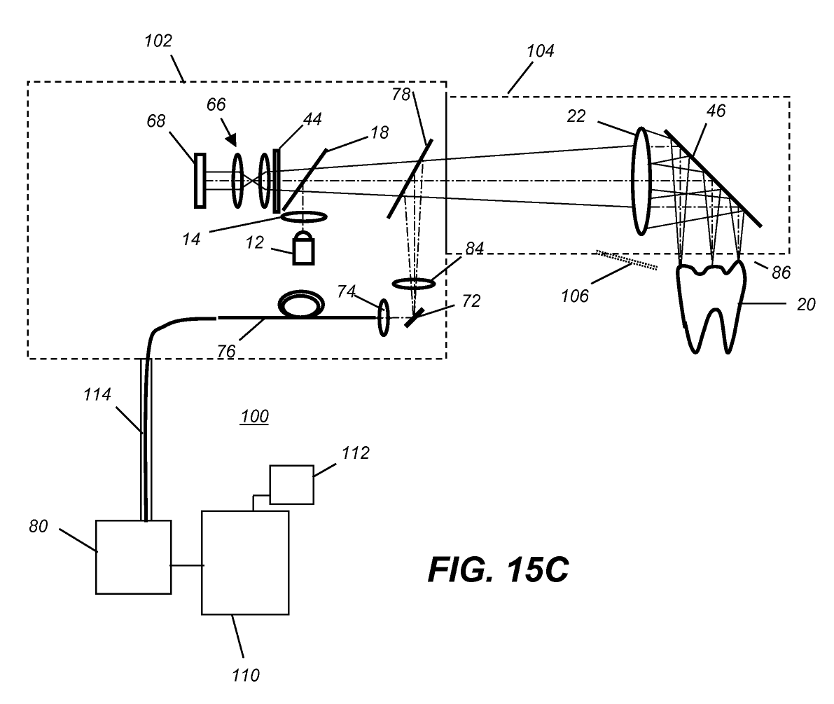

The components of imaging apparatus 10 of the present invention can be packaged in a number of ways, including compact arrangements that are designed for ease of handling by the examining dentist or technician. Referring to FIG. 15A, there is shown an embodiment of a hand-held dental imaging apparatus 100 according to the present invention. Here, an oral imaging probe handle 102, shown in phantom outline, houses light source 12, sensor 68, and their supporting illumination and imaging path components. An oral imaging probe 104 attaches to handle 102 and may act merely as a cover or, in other embodiments, field lens 22 and turning mirror 46 in proper positioning for tooth imaging. Control circuitry and/or computer system 110 can include switches, memory, and control logic for controlling device operation. In one embodiment, control circuitry 110 can simply include one or more switches for controlling components, such as an on/off switch for light source 12. Optionally, the function of control circuitry 110 can be performed at processing apparatus 38 (FIGS. 1-3). In other embodiments, control circuitry 110 can include sensing, storage, and more complex control logic components for managing the operation of hand-held imaging apparatus 100. Control circuitry 110 can connect to an optional wireless interface 136 for connection with a communicating device, such as a remote computer workstation or server, for example.

FIG. 15B is a block diagram showing an arrangement of a hand-held imaging apparatus in one embodiment combining area imaging with OCT. In the configuration shown in FIG. 15B, the OCT apparatus is integrated into the handle 102.

FIG. 15C is a block diagram showing an alternative embodiment of a hand-held imaging apparatus combining OCT with area imaging. In this embodiment that handle 102 has an imaging apparatus cable 114, which includes sample arm optical fiber 76 and necessary electrical cabling for communication with the OCT system 80 and the control circuitry and computer 110.

The probe 104 is removable and it is constructed so that it can be rotated to an arbitrary angle with respect to handle 102. Different probes can be interchanged for examining different types of teeth and for different sized mouths, as for adults or children as required. In addition, the handle can be optionally attached to a dentist stand or instrument rack if desired.

Hand-held dental imaging apparatus 100 may be configured differently for different patients, such as having an adult size and a children's size, for example. In one embodiment, removable probe 104 is provided in different sizes for this purpose. Alternately, probe 104 could be differently configured for the type of tooth or angle used, for example. Probe 104 could be disposable or could be provided with sterilizable contact components. Probe 104 could also be adapted for different types of imaging. In one embodiment, changing probe 104 allows use of different optical components, so that a wider angle imaging probe can be used for some types of imaging and a smaller area imaging probe used for single tooth caries detection. One or more external lenses could be added or attached to probe 104 for specific imaging types.

Probe 104 could also serve as a device for drying tooth 20 to improve imaging. In particular, fluorescence imaging benefits from having a dry tooth surface. In one embodiment, as shown in FIG. 15A, a tube 106 provides an outlet for directing pressurized air or other drying gas onto tooth 20 is provided as part of probe 104. Probe 104 could serve as an air tunnel or conduit for pressurized air; optionally, separate tubing could be required for this purpose.

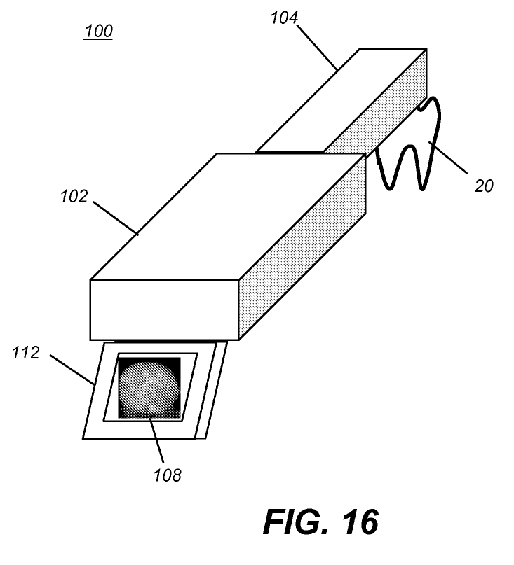

FIG. 16 shows a perspective view of an embodiment of hand-held imaging apparatus 100 having an integrated display 112. Display 112 could be, for example, a liquid crystal (LC) or organic light emitting diode (OLED) display that is coupled to handle 102 as shown. A displayed image 108 could be provided for assisting the dentist or technician in positioning probe 104 appropriately against tooth 20. Using this arrangement, a white light source is used to provide the image 108 on display 112 and remains on unless FIRE imaging is taking place. At an operator command entry, such as pressing a switch on hand-held imaging apparatus 100 or pressing a keyboard key, the white light goes off and the imaging light source is activated, for example, a blue LED. Once the fluorescence and reflectance images are obtained, the white light goes back on. When using display 112 or a conventional video monitor, the white light image helps as a navigation aid. Using a display monitor, the use of white light imaging allows the display of an individual area to the patient.

In order to obtain image 108, probe 104 can be held in position against the tooth, using the tooth surface as a positional reference for imaging. A bite-down may be provided so that the patient can stabilize the probe while on any specific tooth. This provides a stable imaging arrangement and has advantages by defining the optical working distance. Placing probe 104 directly against the tooth, as opposed to some distance away from the tooth surface, has particular advantages for OCT imaging, since it provides a known working distance from the tooth surface, and OCT has a limited range of operating depth.

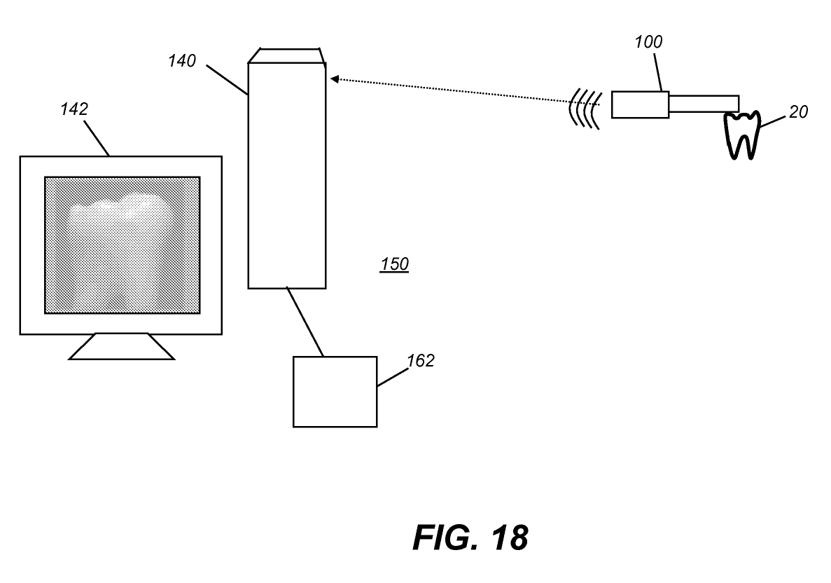

FIG. 18 shows an imaging system 150 using wireless transmission. Hand-held imaging apparatus 100 obtains an image upon operator instruction, such as with the press of a control button or an entry on an instruction entry device 162, such as a mouse, joystick, touch screen, or pointer mechanism, for example. The image can then be sent to a control logic processor 140, such as a computer workstation, server, or dedicated microprocessor based system, for example. A display 142 can then be used to display the image obtained. Wireless connection of hand-held imaging apparatus 100 can be advantageous, allowing imaging data to be obtained at processing apparatus 38 without the need for hardwired connection. Any of a number of wireless interface protocols could be used, such as Bluetooth data transmission, as one example.

### Image Combining Software for Area Imaging

One method for reducing false-positive readings or, similarly, false-negative readings, is to correlate images obtained from multiple sources. For example, images separately obtained using x-ray equipment can be combined with images that have been obtained using imaging apparatus 10 of the present invention. Imaging software, provided in processing apparatus 38 (FIGS. 1-3) allows correlation of images of tooth 20 from different sources, whether obtained solely using imaging apparatus 10 or obtained from some combination of devices including imaging apparatus 10.

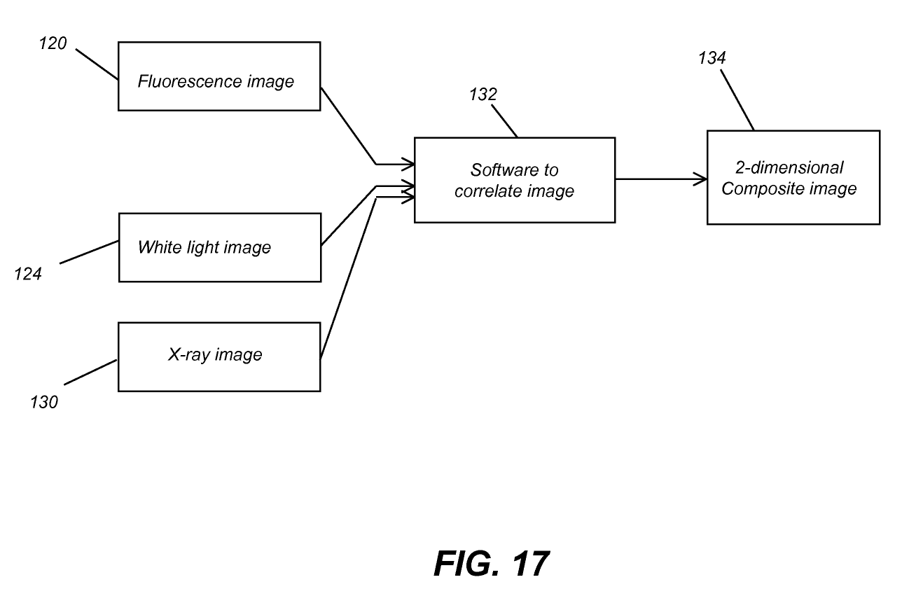

Referring to FIG. 17, there is shown, in block diagram form, a processing scheme using two-dimensional area images from multiple sources to form a composite image 134 in one embodiment. Once it is obtained, composite image 134 can be displayed or can be used by automated diagnosis software in order to identify regions of interest for a specific tooth. The identified regions of interest can then be further analyzed by using OCT imaging tools.

To form 2-dimensional composite image 134, two or more 2-dimensional area images are first obtained. As shown in FIG. 17, these may include two or more of: a fluorescence image 120 obtained from imaging apparatus 10 as described earlier, a white light image 124 from the same source, and an x-ray image 130 obtained from a separate x-ray apparatus. Image correlation software 132 takes two or more of these two-dimensional images and correlates the data accordingly to form a composite image 134 from these multiple image types. In one embodiment, the images are provided upon operator request. The operator specifies a tooth by number and, optionally, indicates the types of image needed or the sources of images to combine. Software in processing apparatus 38 then generates and displays the resultant image.

As one example of the value of using combined two-dimensional images, white light image 124 is particularly useful for identifying stained areas, amalgams, and other tooth conditions and treatments that might otherwise appear to indicate a caries condition. However, as was described earlier, the use of white light illumination is often not sufficient for accurate diagnosis of caries, particularly in its earlier stages. Combining the white light image with some combination that includes one or more of fluorescence and x-ray images helps to provide useful information on tooth condition and to target any areas where OCT imaging will be of particular value. Similarly, any two or more of the three types of images shown in FIG. 17 could be combined by image correlation software 132 for providing a more accurate diagnostic image.

Imaging software can also be used to help minimize or eliminate the effects of specular reflection. Even where polarized light components can provide some measure of isolation from specular reflection, it can be advantageous to eliminate any remaining specular effects using image processing. Data filtering can be used to correct for unwanted specular reflection in the data. Information from other types of imaging can also be used, as is shown in FIG. 17. Another method for compensating for specular reflection is to obtain successive images of the same tooth at different light intensity levels, since the relative amount of specular light detected would increase at a rate different from light due to other effects.

### Operator Interface for Combined Area and OCT Imaging

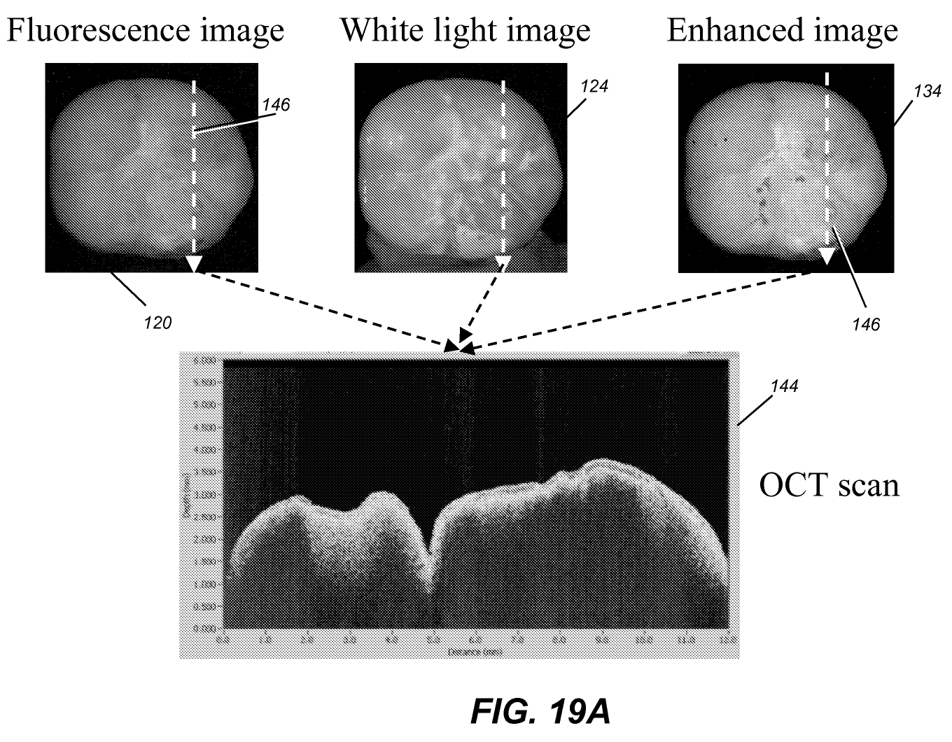

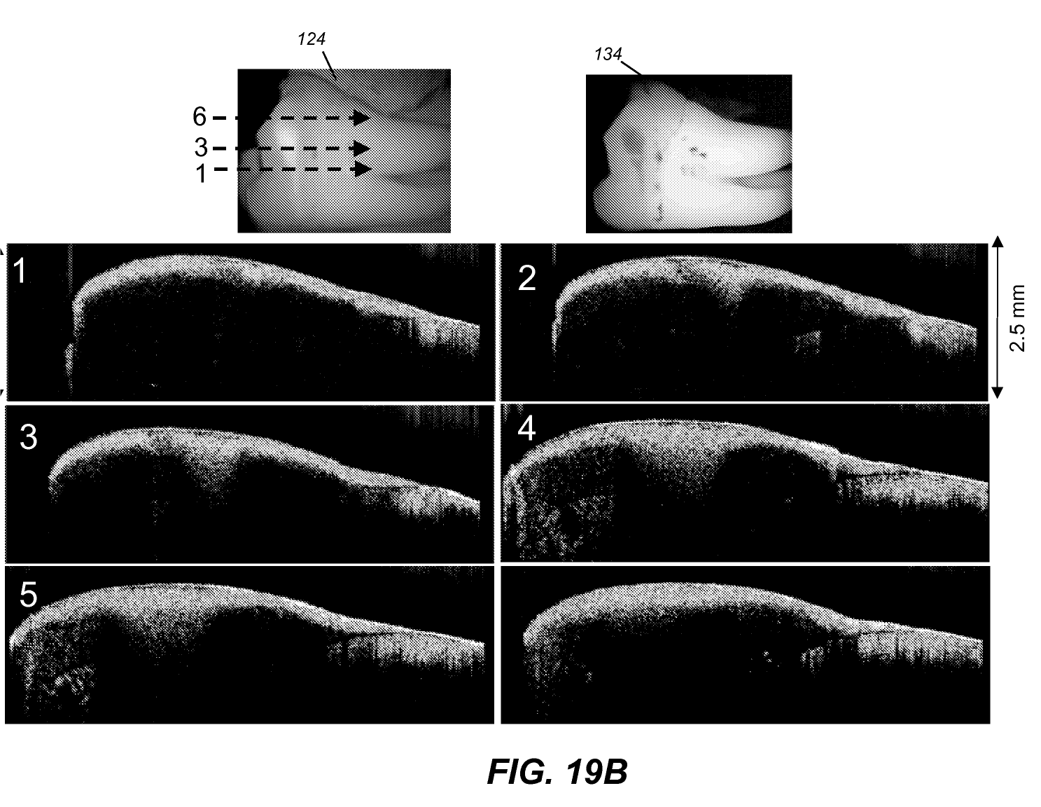

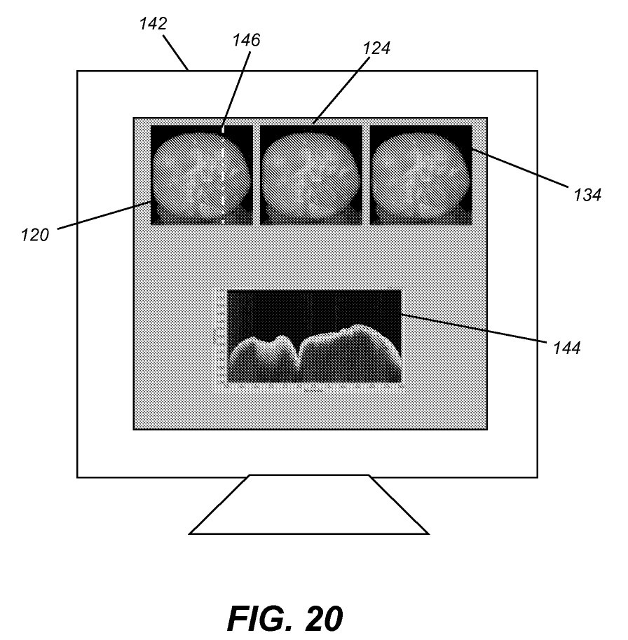

FIG. 19A shows an arrangement of area images and an OCT scan image that can be displayed to an operator. In one embodiment, as shown in FIG. 20, 2-dimensional area images and OCT images appear simultaneously on a display 142. Here, fluorescence image 120, white light image 124, and composite image 134 are area images that show the tooth surface, as described previously. A marker 146 is displayed on at least one of the area images, indicating the location of an OCT scan image 144 and its area. In the example shown in FIG. 19, mark 146 is a line, so that OCT scan image 144 has the appearance of a cross-sectional slice. OCT scan image 144 consists of 2000 pts per depth scan of 6.0 mm total distance and 840 pts along the horizontal scan line of total distance of 12 mm.

FIG. 19B shows a second example of displaying multiple OCT line scan images over a region of interest along with a white light image and a FIRE area image of the tooth. The depth scale is 2.5 mm obtained at 3 microns per point and the horizontal axis is 7 mm obtained at 70 points per mm. There is ½ mm along the y axis steps between adjacent scans shown as line scans 1 to line 6 in FIG. 19B.

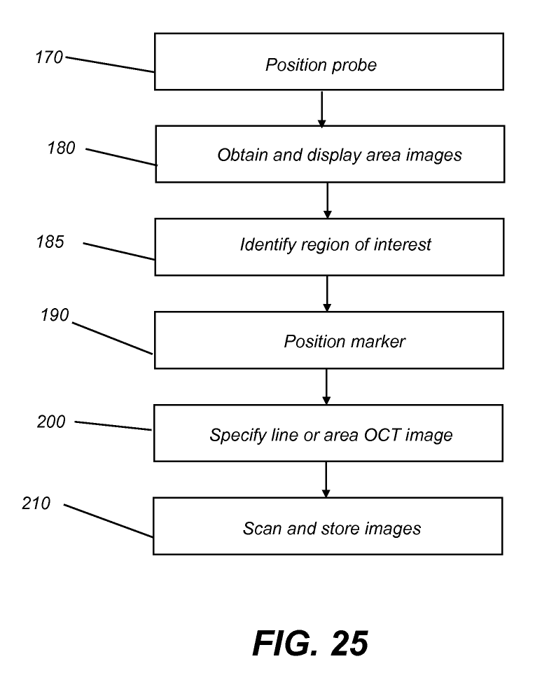

As has been noted earlier, operator interaction with imaging system 150 can be used to specify the portion of tooth 20 that is to be imaged using OCT. The flow diagram of FIG. 25 shows a sequence of operator steps that are used to obtain an OCT image in one embodiment. In a probe positioning step 170, the operator, typically a dentist or dental technician, positions the probe against the tooth to be imaged. The probe is held against the tooth, in a stable position. This may be provided using a bite-down device or with some other type of stabilizing feature supporting the imaging end of the probe. An area imaging step 180 follows, during which one or more area images are generated and displayed on a display screen. Area images may be any proper subset of the set of images described earlier including white light image 124, fluorescence image 120, and composite image 134, for example. In the embodiment of FIG. 20, white light image 124, fluorescence image 120, and composite image 134 all display as area images. The operator may initiate capture of these images when the probe is positioned, such as by entering a command using a workstation keyboard or mouse selection or by pressing a control button on the probe itself. Alternately, the system may continuously (that is, repeatedly) perform this area imaging process, so that the operator continuously has a reference image displayed, enabling the operator to determine whether or not the probe is suitably positioned and the area image is in clear focus before proceeding to a later step.

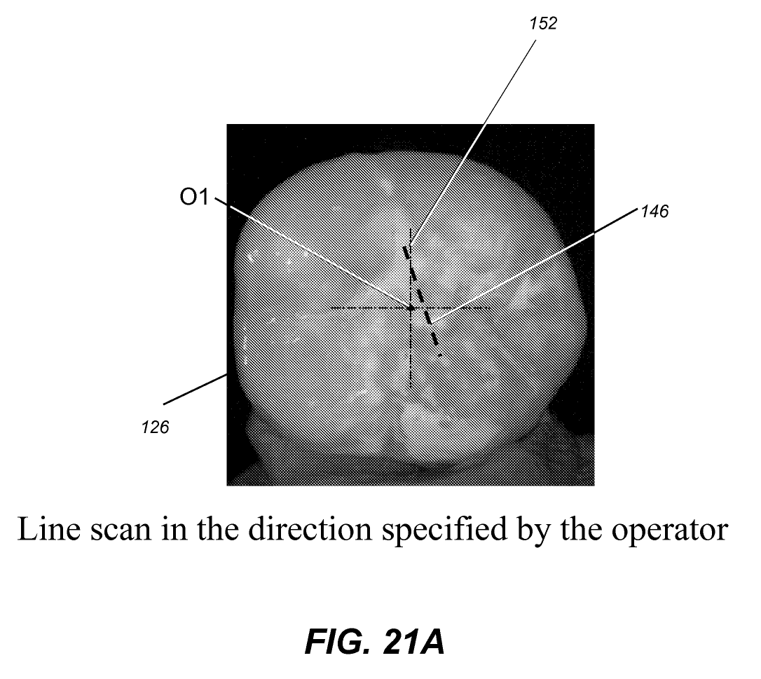

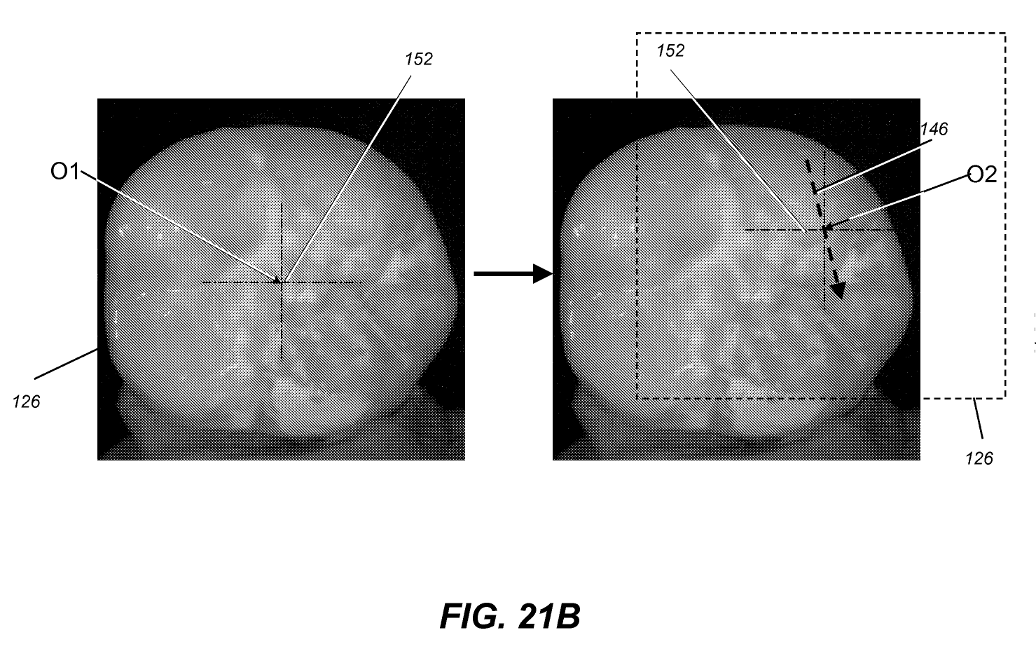

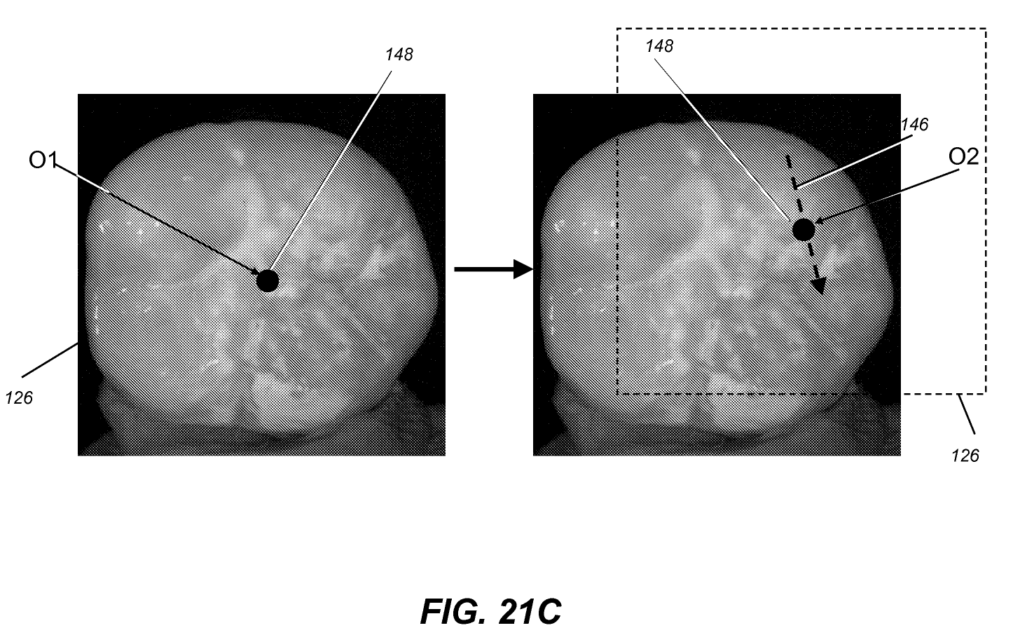

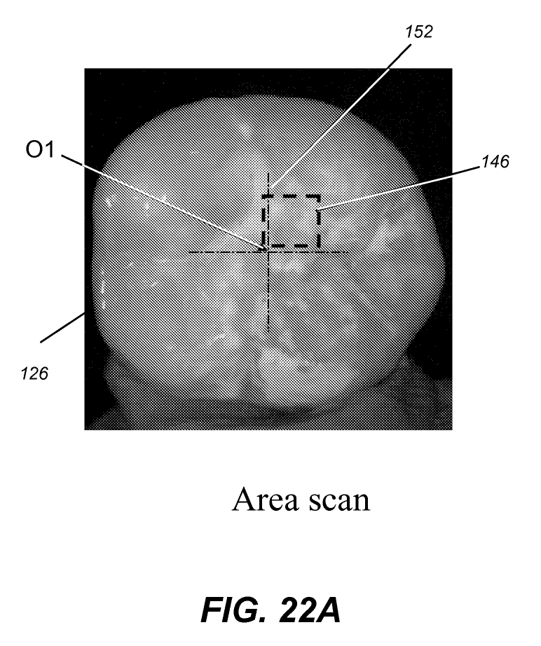

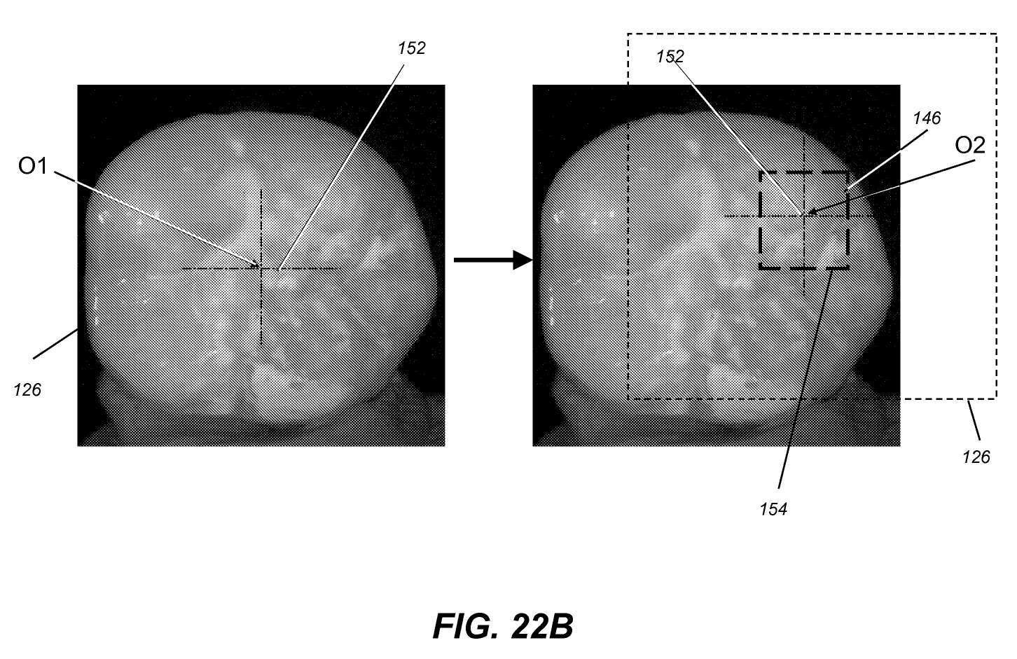

Once the oral imaging probe is in position and at least one area image displays, an identify a region of interest step 185 is performed. This can be performed automatically by imaging software or by the operator. Following identification of the region of interest step, a marker positioning step 190 is executed in which the location and area in the region of interest for the OCT scan is defined. As is shown in FIGS. 21A, 21B, 21C and 22A, 22B, crosshairs 152, a light indicator 148, or other reference can be positioned suitably with respect to the tooth. The light indicator can emanate from light source 80b and it could indicate the present location of the OCT scanning element 72 on the tooth, Preferably the OCT scanning position would be centered on the scanning lens 84 so as to maximize the possible scanning area during this step. Alternatively, the center of the crosshairs could indicate the center position of the OCT scanning range. For a line scan, operating a control such as a rotating thumbwheel on the oral imaging probe handle itself can be used to pivot marker 146 relative to crosshairs 152, light indicator 148, or similar reference. Optionally, a mouse or joystick could be used by the operator or a touch screen interface could be employed for accepting the operator instruction. In one embodiment, an OCT area image is simply defined by a fixed size rectangle that is centered with respect to the crosshairs 152 origin. The rectangle can changed in size and orientation by appropriate instructions.

Then, in an OCT area specification step 200, the operator can specify whether a line scan or an area scan is desired as well as the direction, scan starting position, number of points in a scan and the total number of scans over the area. As an example the scan area 154 selected in FIG. 22B is a 4 mm square region. Repetitive line scans will be performed on the tooth. The operator can select to start in the top left corner of the region and to scan left to right in a raster fashion with a 25 micron step size down the y axis as an example. The operator can also select the scan depth if desired. Typically for occlusal surfaces of molars it is recommended that the scanning depth be on the order of 6 mm to account for differences in height of a tooth surface in molars. After the OCT scanning region is identified the OCT scans are obtained as in step 210 of FIG. 25. Typically the OCT displays are shown on the display screen in sequence as they are being generated.

FIGS. 21A-21C and 22A-22B show how the operator can specify the location and area of the OCT scan in different embodiments. For these examples, the optical axis of the OCT scanning components is the same as the optical axis for area imaging. As shown in FIGS. 21A-21C and 22A-22B, some type of target is provided on an area image displayed in a live window 126 in order to indicate the location of this optical axis. In FIG. 21A, for example, crosshairs 152 indicate the optical axis location on an area image, at a reference point O1. The optical axis indicates a center point for the OCT scan. The operator can move crosshairs 152 or other target in order to center this reference at a desired point on the tooth. For instance, as shown in FIG. 21B, crosshairs 152 can be moved by the operator to a second reference point O2 as the target for OCT scanning. As noted earlier, the area image that displays in live window 126 and permits repositioning of crosshairs 152 or other target can be composite image 134 or any of its component images, such as x-ray image 130 or white light image 124, for example. As shown in FIG. 21C, light indicator 148 may be provided as an alternative target type, instead of crosshairs 152. Light indicator 148 can be generated by light from the probe itself, such as a laser or LED can provide. Light source 80b (FIG. 13B) could also be used for this purpose.

Within live image 126, a marker 146 is provided, positioned relative to crosshairs 152 or other target. Marker 146 identifies the scan area or line scan direction and can also be repositioned by the operator. In one embodiment, marker 146 is movable over a small range of dimensions, corresponding to the dimensions that can be reached by OCT scanning with the optical axis in the current position. This is determined by the maximum clear aperture of scanning lens 84 and the scanning element 72. Thus, an operator attempt to move marker 146 beyond the area that can be scanned by OCT optics is defeated by control logic. In order to move marker 146 outside of this range, it is necessary for the operator to first reposition the probe so that the optical axis indicated by crosshairs 152 or light indicator 148 is roughly in the center of the region requires OCT scan, as shown in FIGS. 21B and 21C. Alternatively the probe may have built in repositioning capability to automatically center the probe OCT scan center on the desired marker position.

In FIGS. 21A, 21B, and 21C, marker 146 indicates that the OCT scan is a line scan and shows the position and angular orientation of the line, both of which can be readjusted by the operator. In FIGS. 22A and 22B, marker 146 designates an area scan that may be repositioned and resized but, in one particular embodiment, has a fixed rectangular shape and size. In other embodiments, area scans can have other shapes, such as ellipses or circles, polygons, or operator-defined shapes and may be adjustable in size.

One advantage of light indicator 148 relates to its correspondence to the optical axis of the scanning probe. In one embodiment, light indicator 148 can also visibly track the OCT scanning action, showing the operator, by means of live window 126 display, the actual location of the OCT sample beam at any point in the scan.

Selection, positioning and sizing of marker 146 is performed in any of a number of ways. In one embodiment, the imaging probe itself includes controls that allow the operator to configure each of these functions for marker 146. In another embodiment, a combination of controls on the probe and on a keyboard or console of control logic processor 140 (FIG. 18), or touch screen of display 142, enable operator commands to select, size, and position the area for OCT scanning, all based on the display in live window 126. Initiation of the OCT scan can begin with a button press on the probe or with some other mechanism for obtaining an operator instruction, including a voice-actuated mechanism, for example.

It is important to emphasize the distinction between the following:
(i) the area image of the tooth that is obtained from one or more x-ray, white light, fluorescence images; and
(ii) the OCT image.
   The OCT image is obtained over a scanning area that may be a line relative to the surface (that is, may be over a scanned area that is one pixel wide, several pixels in length, and several pixels in depth relative to the surface) or may be an area relative to the surface (that is, formed from adjacent scanned lines so that the area is several pixels wide, several pixels in length and several pixels in depth, again relative to the surface).

Automatic generation of the OCT image is also possible, based on image processing of the area image and automated detection of a region of interest from the area image.

Once the OCT image is generated, whether following an operator instruction or automatically, the OCT image is displayed to the operator. An optional storage step 210 (FIG. 25) follows, in which image data for the OCT image and any of the area images can be stored on a suitable storage device such as those found in a computer system and further processed for later use.

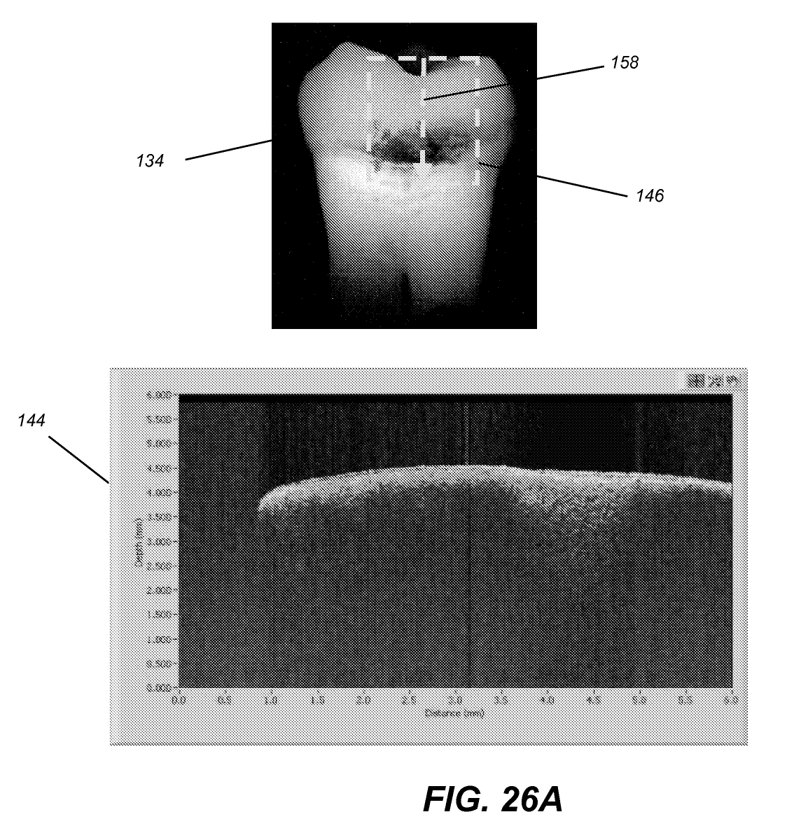

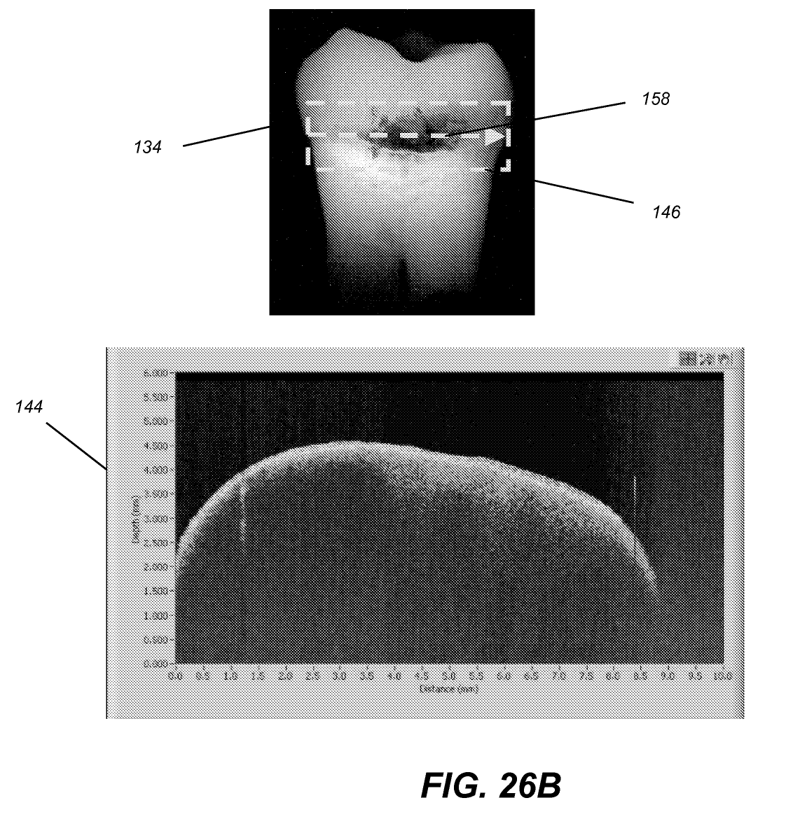

Referring to FIG. 26A, there is shown one method for displaying OCT image data to the operator in a meaningful fashion. An index line 158 lies within marker 146 located on composite image 134, which is registered to the tooth and indicates the scanned line scanned using OCT techniques. An OCT scan image 144 that corresponds to index line 158 also displays. The operator can reposition index line 158, such as using controls on the probe or on the display, to sequence through individual OCT scan lines. OCT scan image 144 changes accordingly as does the position of index line 158. Because this capability operates on stored data, other operator interface tools can also be used to move index line 158 and sequence through this set of images. Index line 158 could be moved in any direction within the display plane, such as up and down, left and right, or rotating. Entry of spatial coordinates could alternately be used for selecting any position of index line 158 and displaying the corresponding OCT scan image. A second set of data using a different region of interest and scan direction is shown in FIG. 26B for reference.

Data from storage step 200 can also be used to coordinate imaging sessions performed on a tooth at different times. For example, for an image obtained at a time t1, a stored area image such as white-light image 124 can be displayed with marker 146 and the stored OCT image obtained for that marker 146. With the earlier results displayed, an operator can obtain a new image of the same area at a time t2 by obtaining a new area image for the same tooth, manipulating the rotation of the new area image to align it visually with the earlier area image, and placing and orienting the new marker 146 for OCT imaging. Feature-detecting algorithms could also be employed in order to automate the steps needed to obtain an OCT image that corresponds to the position of an earlier OCT image.

Once the OCT scan data for a tooth is obtained and stored, a number of imaging tools can be used to display this data in a useful manner. Since an area scan obtains multiple scanned lines in raster fashion, 3-dimensional (3-D) imaging tools can be employed in order to show the “topography” of a region of interest. Such a 3-D image can provide information on the position of a suspicious area, its size and depth, and the overall topography of surrounding tooth tissue. In many cases, depth and size data can be used in order to ascertain the severity of a caries condition. Automated tools can be used to analyze this data and to display such areas using highlighting features, for example.

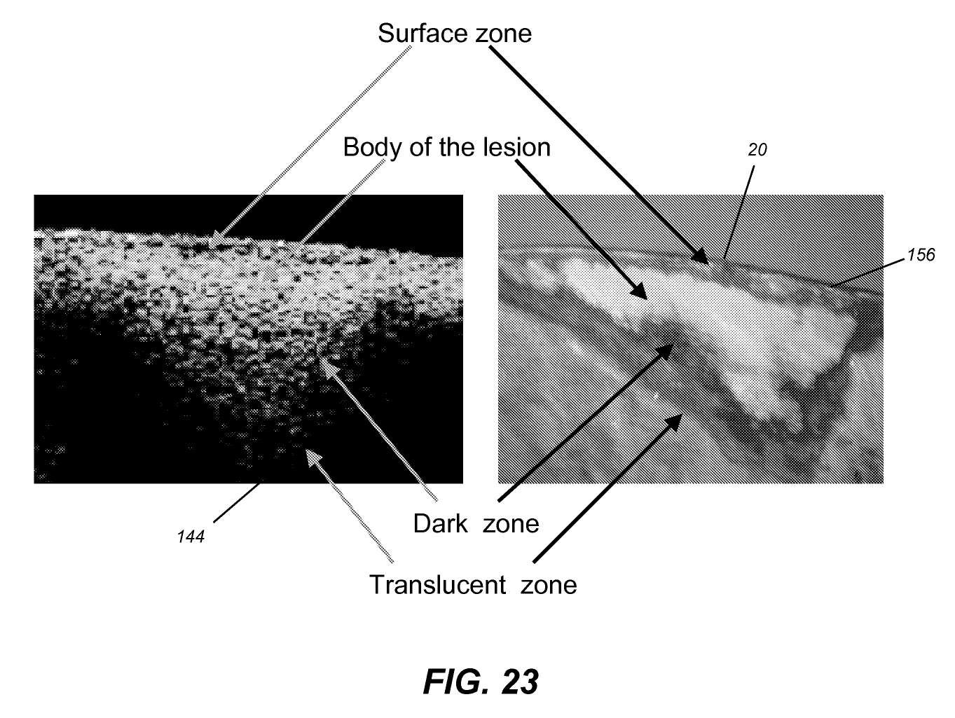

FIG. 23 compares the line OCT data of OCT scan image 144 with a microscopic image 156 of the sectioned tooth obtained using a polarization microscope. As can be seem from those two images, OCT can provide tooth structure information of caries, which cannot be obtained by any other technologies without sectioning the tooth.

### Index Matching Gel

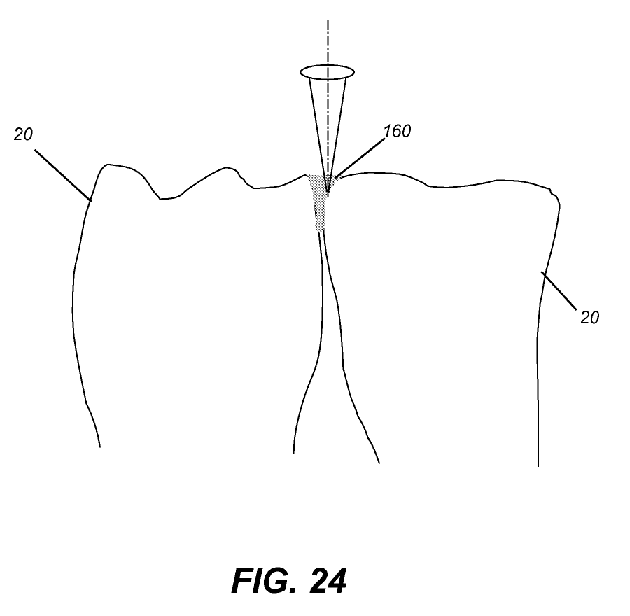

There can be some imaging conditions for which additional measures may be taken to improve quality and prevent undesirable optical effects as well as to obtain more useful information from interproximal surfaces. Referring to the interproximal area represented in outline in FIG. 24, tooth slope at the interproximal surface is large, relative to the angle of incident light, represented as coming from above. As a result, without some corrective measure, a large percentage of the light from the sample arm of the probe is reflected by the enamel surface. Also, a small percentage of the scattered light inside the tooth can be captured by the collection lens and coupled back to the probe interferometer due to this large slope. In order to increase the light entering the enamel and to capture more scattered light, an index matching material can be used. With index matching material such as an index matching gel 160 the reflection from the enamel surface can be reduced significantly, and more scattered light can be collected by the OCT object lens of the probe.

In the above discussions we have described all of the area images and OCT images as if they were coming from a single tooth. The description of the methods and apparatus can readily be extended to more than one tooth. In particular, it is of interest to investigate interproximal caries which forms at the junction between two adjacent teeth. Thus, all of the above area image descriptions can be extended to include area images of multiple teeth. Furthermore, it is not necessary that the area image of a tooth require that there is an image of an entire tooth surface. It is understood that the area images can be of partial teeth since the entire tooth may not be in the field of view.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

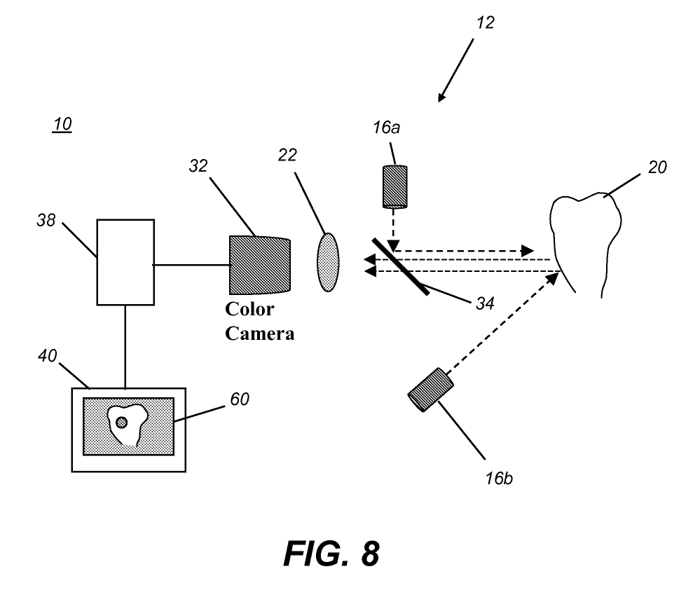

For example, various types of light sources 12 could be used, with various different embodiments employing a camera or other type of image sensor. While a single light source 12 could be used for fluorescence excitation, it may be beneficial to apply light from multiple incident light sources 12 for obtaining multiple images. Referring to the alternate embodiment of FIG. 8, light source 12 might be a more complex assembly that includes one light source 16a for providing light of appropriate energy level and wavelength for exciting fluorescent emission and another light source 16b for providing illumination at different times. The additional light source 16b could provide light at wavelength and energy levels best suited for backscattered reflectance imaging. Or, it could provide white light illumination, or other multicolor illumination, for capturing a white light image or multicolor image which, when displayed side-by-side with a FIRE image, can help to identify features that might otherwise confound caries detection, such as stains or hypo-calcification. The white light image itself might also provide the backscattered reflectance data that is used with the fluorescence data for generating the FIRE image. Supporting optics for both illumination and image-bearing light paths could have any number of forms. A variety of support components could be fitted about the tooth and used by the dentist or dental technician who obtains the images. Such components might be used, for example, to appropriately position the light source or sensing elements or to ease patient discomfort during imaging.

Thus, what is provided is an apparatus and method for caries detection using low coherence OCT imaging over a region of interest defined by taking an area image of a tooth.

### Parts List

10 imaging apparatus
12 light source
12a light source
12b light source
13 diffuser
14 lens
15 light source combiner
16a light source
16b light source
18 polarizing beamsplitter
20 tooth
22 field lens
26 filter
28 filter
30 camera
32 camera
34 beamsplitter
38 processing apparatus
40 display
42 polarizer
42a polarizer
42b polarizer
44 analyzer
46 turning mirror
50 fluorescence image
52 reflectance image
54 white-light image
58 carious region
60 FIRE image
62 threshold image
64 enhanced threshold FIRE image
66 lens
68 sensor
70 OCT imager
72 scanning element
74 lens
76 sample arm optical fiber
78 dichroic filter
80 OCT system
80a OCT light source
80b visible light source
80c coupler
80d coupler (interferometer)
80e reference arm optical fiber
80f detector and detection electronics
80g signal processing electronics
80h control logic processor
80i reference delay depth scanner
82 turning mirror
84 scanning lens
86 aperture
90 area of interest
100 imaging apparatus
102 handle
104 probe
106 tube
108 image
110 control circuitry and/or computer
112 display
114 imaging apparatus cable
120 fluorescence image
124 white light image
126 live window
130 x-ray image
132 image correlation software
134 composite image
136 wireless interface
140 control logic processor
142 display
144 OCT scan image
146 marker for OCT scan line or area
148 light indicator
150 imaging system
152 crosshairs
154 scan area
156 microscopic image
158 index line
160 index-matching gel
162 instruction entry device
170 probe positioning step
180 area imaging step
185 identify region of interest step
190 marker positioning step
200 OCT area specification step
210 storage step

1. A method for obtaining an image of a tooth comprising:
a) obtaining at least one area image of a tooth surface;
b) identifying a region of interest from the at least one area image;
c) positioning a marker on the at least one area image, the marker corresponding to at least a portion of the region of interest;
d) identifying a scanning area; and
e) obtaining an optical coherence tomography (OCT) image over the scanning area.

2. The method according to claim 1 wherein obtaining the at least one area image comprises:
a) directing incident light toward the tooth, wherein the incident light excites a fluorescent emission from the tooth; and
b) obtaining a fluorescence image from the fluorescent emission.

3. The method according to claim 1 wherein obtaining the at least one area image comprises obtaining a reflectance light image from the tooth.

4. The method according to claim 1 wherein identifying the region of interest comprises processing image data from the at least one area image.

5. The method according to claim 1 wherein:
the at least one area image is viewed on a display screen; and the region of interest is identified and the marker is positioned and viewed on the display screen.

6. The method according to claim 1 wherein the OCT image obtained is a single line scan.

7. The method according to claim 1 wherein the OCT image obtained comprises a plurality of adjacent line scans.

8. The method of claim 1 wherein the scanning area for OCT is a polygon or an ellipse.

9. The method according to claim 1 wherein positioning the marker comprises moving an oral imaging probe between positions on the tooth surface.

10. The method according to claim 1 wherein positioning the marker comprises the step of operating a control on an oral imaging probe handle.

11. The method according to claim 1 wherein positioning the marker comprises moving a crosshairs target.

12. The method according to claim 1 wherein positioning the marker further comprises performing image processing on the region of interest from the at least one area image.

13. The method according to claim 1 wherein:
the at least one area image is selected from a group consisting of white light, reflectance, trans illumination, fluorescence, processed image, or x-ray.

14. The method according to claim 1 wherein a tooth is defined as multiple teeth.

15. A method for obtaining an image of a tooth comprising:
a) displaying an area image of a tooth surface;
b) displaying a marker on the area image in response to an operator instruction, the marker indicating a region of interest and identifying a scanning area;
c) obtaining an optical coherence tomography (OCT) image over at least a portion of the scanning area; and
d) displaying the OCT image.

16. The method of claim 15 wherein displaying an area image comprises displaying a reflectance image.

17. The method of claim 15 wherein displaying an area image comprises displaying a fluorescence image.

18. The method of claim 15 wherein the operator instruction comprises moving an oral imaging probe.

19. The method of claim 15 wherein the scanning area for OCT comprises a line.

20. The method of claim 15 wherein the scanning area for OCT is a polygon or an ellipse.

21. The method according to claim 15 wherein a tooth is defined as multiple teeth.

22. A method for obtaining an optical coherence tomography (OCT) image of a tooth comprising:
a) obtaining at least one area image of a tooth surface;
b) processing the at least one area image to identify a scanning area;
c) obtaining OCT measurements over at least a portion of the scanning area; and
d) forming the OCT image according to the OCT measurements.

23. The method according to claim 22 further comprising:
a) displaying the at least one area image of the tooth surface;
b) displaying a marker on the area image indicating the scanning area; and
c) displaying the OCT image.

24. A method for obtaining an image of a tooth comprising:
a) obtaining at least one area image of a tooth;
b) identifying a region of interest from the at least one area image;
c) positioning a marker on the at least one area image, the marker corresponding to at least a portion of the region of interest;
d) identifying a scanning area; and
e) obtaining an optical coherence tomography (OCT) image over the scanning area.

25. A method for obtaining an image of a tooth comprising:
a) displaying an area image of the tooth;
b) processing the area image data to identify a scanning area;
c) displaying a marker on the area image indicating the scanning area;
d) obtaining an optical coherence tomography (OCT) image over the scanning area; and
e) displaying the OCT image.

26. The method according to claim 25 wherein displaying the area image further comprises:
a) obtaining image data from fluorescent emission from the tooth;
b) obtaining image data from reflection from the tooth; and
c) combining the fluorescence and reflectance image data to form the area image.

27. The method according to claim 25 wherein the scanning area is a line.

28. The method according to claim 25 wherein the scanning area is a polygon or an ellipse.

29. A handheld dental imaging apparatus for obtaining an image of a tooth comprising:
a) an optical system for area imaging comprising:
(i) a light source that directs light toward an output aperture for illuminating the tooth;
(ii) guiding optics for directing light obtained from the tooth to a sensor, wherein the sensor forms area image data;
b) an optical system for obtaining an optical coherence tomography (OCT) image; and
c) a display attached to a probe and in communication with the sensor and providing a display image according to the area image data formed by the sensor.

30. The probe according to claim 29 wherein the display is an OLED.

31. The probe according to claim 29 wherein the display is a liquid crystal device.

32. The method according to claim 29 wherein a tooth is defined as multiple teeth.

33. A method for obtaining an image of a tooth comprising:
a) displaying a first area image of a tooth surface;
b) displaying a first marker on the first area image in response to a first operator instruction, the marker indicating a region of interest and identifying a scanning area;
c) obtaining a first optical coherence tomography (OCT) image over the scanning area;
d) computing mapping coordinates for the scanning area;
e) storing the mapping coordinates;
f) displaying a second area image of the tooth surface;
g) identifying the scanning area according to the stored mapping coordinates;
h) obtaining a second OCT image over the scanning area;
i) comparing the first and second OCT images; and
j) reporting results of the comparison of first and second OCT images.

34. An apparatus for obtaining an image of a tooth comprising:
a) an area imaging system for obtaining a two-dimensional real image of a tooth surface, comprising:
(i) an area light source that directs light toward an output aperture for illuminating the tooth;
(ii) guiding optics for directing light obtained from the tooth to a sensor, wherein the sensor forms area image data;
(iii) a display in communication with the sensor for displaying the area image data obtained there from;
(iv) an instruction entry device for positioning a marker on the area image, the marker identifying a scanning area;
b) an optical coherence tomography (OCT) imaging system for obtaining an OCT image over the scanning area, comprising:
(i) a low coherence light source;
(ii) light guiding components that split the low coherence light into a sample path that is directed toward the output aperture and a reference path; and
(iii) a control logic processor for obtaining the OCT image according to light returned from the sample and reference paths.

35. The apparatus according to claim 34 wherein the instruction entry device is taken from the group consisting of a thumbwheel, a touch screen, a mouse, and a joystick.

36. The apparatus according to claim 34 wherein the instruction entry device further comprises a computer.

37. The method according to claim 34 wherein a tooth is defined as multiple teeth.

38. A method for obtaining an image of a tooth comprising:
a) positioning a probe against the tooth in a stable position;
b) obtaining at least one area image of a tooth surface and viewing it on a display screen;
c) identifying a region of interest from the at least one area image;
d) positioning a marker on the at least one area image and viewing it on the display screen, the marker corresponding to at least a portion of the region of interest;
e) identifying an optical coherence tomography (OCT) scanning area, scan start coordinate, scanning direction and number of scans over the area;
f) obtaining successive (OCT) line scan images over the scanning area and displaying each successive OCT line scan image on the display screen; and
g) displaying an index line on the display screen of the at least one area image indicating the position of each successive OCT line scan image on the display screen as it is being generated.

39. The method according to claim 38 wherein the data for the at least one area image and each successive OCT image is stored on a storage device.

40. The method according to claim 38 wherein a tooth is defined as multiple teeth.
